(19) United States
(12) Patent Application Publication
(10) Pub. No.: US 2020/0341395 A1
(43) Pub. Date: Oct. 29, 2020

(54) TONER

(71) Applicant: CANON KABUSHIKI KAISHA, Tokyo (JP)

(72) Inventors: Kenji Ookubo, Numazu-shi (JP); Takayuki Toyoda, Suntou-gun (JP); Taku Shimoda, Machida-shi (JP); Masashi Kawamura, Yokohama-shi (JP)

(21) Appl. No.: 16/847,982

(22) Filed: Apr. 14, 2020

(30) Foreign Application Priority Data
Apr. 25, 2019 (JP) 2019-083660

(51) Int. Cl. G03G 9/087; C08G 63/91

(52) U.S. Cl. CPC G03G 9/08755; C08G 63/916

(57) ABSTRACT

A toner comprising a toner particle that contains a resin A, wherein the resin A contains an ester bond, and has a substituted or unsubstituted silyl group in a molecule thereof, a substituent on the substituted silyl group is at least one selected from the group consisting of alkyl groups, alkoxy groups, hydroxy groups, aryl groups, and halogen atoms; and a content of the ester bond in the resin A is at least 12.0 mass %.

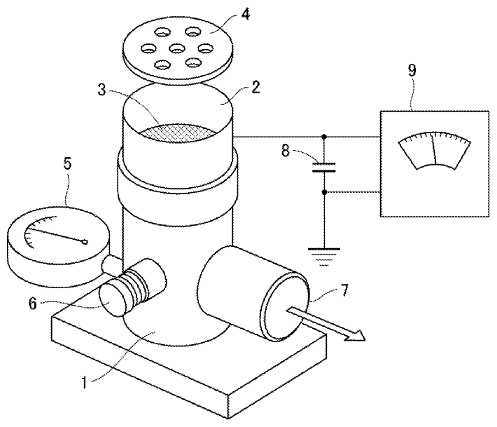

### BACKGROUND OF THE INVENTION

### Field of the Invention

The present invention relates to the toner used in recording methods that utilize, for example, an electrophotographic system.

### Description of the Related Art

Image-forming devices, e.g., copiers, printers, and so forth, have been subject in recent years to an increasing diversification of intended applications and use environments, and in combination with this have been subject to demands for higher speeds and higher image qualities.

Numerous methods are known for electrophotographic systems. In an electrophotographic system, generally an electrostatic latent image is formed on an electrostatic image bearing member (also referred to herebelow as a “photosensitive member”) by various means through the use of a photoconductive material. This latent image is then made visible by carrying out development with a toner, and as necessary the toner image is transferred to a recording medium, e.g., paper. The toner image on the recording medium is then fixed using, e.g., heat or pressure, to obtain the copied article. Copiers and printers are examples of image-forming devices that use such an electrophotographic system.

A rapid charge rise by the toner is required of these copiers and printers in order to have a high speed coexist with a high image quality. A large amount of art has been disclosed with respect to this problem.

Japanese Patent Application Laid-open No. 2001-343787 discloses art that brings about an improvement in the charge rise performance through the use, as the binder resin, of a nonlinear polyester resin that contains a metallic compound of an aromatic oxycarboxylic acid with a central metal having a valence of 3 or more.

Japanese Patent Application Laid-open No. 2011-138000 discloses art that brings about an improvement in the charge rise performance through the use of a polyester resin that contains an aromatic ring having the methoxy group, hydroxy group, and carboxy group.

Japanese Patent Application Laid-open No. 2018-151629 discloses art that brings about an improvement in the charge rise performance by stipulating the aromatic carboxylic acid ratio in the carboxylic acid component constituting a polyester resin.

### SUMMARY OF THE INVENTION

However, even for the toners described in the aforementioned documents, the charge rise characteristics in particular in high-temperature, high-humidity environments cannot be said to be satisfactory and additional improvements are required.

The present invention provides a toner that exhibits an excellent charge rise performance in high-temperature, high-humidity environments.

The present invention relates to a toner comprising a toner particle that contains a resin A, wherein

the resin A contains an ester bond, and has a substituted or unsubstituted silyl group in a molecule thereof,

a substituent on the substituted silyl group is at least one selected from the group consisting of alkyl groups, alkoxy groups, hydroxy groups, aryl groups, and halogen atoms; and

a content of the ester bond in the resin A is at least 12.0 mass %.

The present invention can provide a toner that exhibits an excellent charge rise performance in high-temperature, high-humidity environments.

Further features of the present invention will become apparent from the following description of exemplary embodiments with reference to the attached drawings.

### BRIEF DESCRIPTION OF THE DRAWINGS

The FIGURE is a schematic drawing of an instrument for measuring the charge amount.

### DESCRIPTION OF THE EMBODIMENTS

Embodiments are described in detail in the following, but this should not be construed to mean that the present invention is limited to or by the following description.

Unless specifically indicated otherwise, the expressions “from XX to YY” and “XX to YY” that show numerical value ranges refer in the present invention to numerical value ranges that include the lower limit and upper limit that are the end points.

In addition, monomer unit refers to the reacted form of a monomer material in the polymer or resin.

The toner is a toner comprising a toner particle that contains a resin A, wherein

the resin A contains an ester bond, and has a substituted or unsubstituted silyl group in a molecule thereof,

a substituent on the substituted silyl group is at least one selected from the group consisting of alkyl groups, alkoxy groups, hydroxy groups, aryl groups, and halogen atoms; and

a content of the ester bond in the resin A is at least 12.0 mass %.

By having the toner adopt the constitution described in the preceding, the toner then exhibits excellent charge rise characteristics in high-temperature, high-humidity environments. While the detailed reason is unclear, the following is hypothesized.

Conventional toners have achieved an improvement in the charge rise performance through the use of a high-polarity material in the toner. For example, the charge rise performance is improved in accordance with Japanese Patent Application Laid-open No. 2018-151629 through the use of an aromatic carboxylic acid.

When a high-polarity material is used, the charge rise performance is improved in low-humidity environments. However, polar materials readily absorb moisture in high-humidity environments. Once a polar material has absorbed moisture, the resistance declines due to the effect of the water and charge leakage then ends up occurring and the charge rise performance declines as a consequence.

As a result, the conventional approach, i.e., improving the charge rise performance by using a polar material that has the carboxy group or sulfo group, while being able to improve the charge rise performance in low-humidity environments, has been inadequate for improving the charge rise performance in high-humidity environments.

With the above toner, on the other hand, through charge transfer between the ester bond and silicon atom in the resin A, the charge at the toner surface is diffused and additional charging is made possible. As a consequence, the charge rise performance can be improved without using a high-polarity material.

Considering this in greater detail, polarization is produced within the C═O in the ester bond due to the different electronegativities of carbon and oxygen. In addition, when the silicon atom (Si) is present in its neighborhood, polarization is also produced between the Si and O. Charge transfer is produced mediated by the polarization within the C═O and between the Si and O.

Due to this, the charge produced at the toner surface by triboelectric charging diffuses via charge transfer at the resin A, which contains the ester bond and contains a substituted or unsubstituted silyl group within the molecule, and the charge density at the toner surface then declines. As a result, the toner surface can undergo further charging and rapid charging can occur as a consequence.

In addition, since it is the ester bond, which is less polar than the carboxy group and sulfo group, that contributes to the charge rise performance, moisture absorption is then made more difficult even in high-humidity environments. Due to this, the charge rise performance can be improved even in high-humidity environments.

The resin A contains an ester bond and has, in the molecule thereof, a substituted or unsubstituted silyl group wherein the substituent on the substituted silyl group is at least one selected from the group consisting of alkyl groups, alkoxy groups, hydroxy group, aryl groups, and halogen atoms.

The phrase “contains an ester bond” means that the characteristic group (—CO—O—) of carboxylate esters is incorporated.

This resin A should satisfy the conditions indicated above, but is not otherwise particularly limited; it can be exemplified by ester bond-bearing resins provided by the reaction of, e.g., a silane coupling agent or hydrosilane, ester bond-bearing polymers of organosilane compounds, and ester bond-bearing hybrid resins of the preceding.

At a more specific level, examples are silane-modified vinyl resins, silane-modified polyester resins, silane-modified polycarbonate resins, silane-modified polyurethane resins, silane-modified phenolic resins, silane-modified epoxy resins, silane-modified polyolefin resins, silicone-modified resins, and so forth, in each case having the ester bond.

The ester bond may be originally present as a constituent component of the resin, or may be introduced later, for example, through a dehydration condensation between a carboxy group (or hydroxy group)-bearing resin with an alcohol (or carboxylic acid).

Ester bond-bearing silane-modified vinyl resins can be exemplified by ester bond-bearing silane-modified vinyl resins produced by the vinyl polymerization of, for example, an ester bond-bearing vinyl compound with a vinyl compound having a substituted or unsubstituted silyl group.

The following, for example, can be used as the ester bond-bearing vinyl compound: methyl acrylate, ethyl acrylate, butyl acrylate, octyl acrylate, dimethylaminoethyl acrylate, methyl methacrylate, ethyl methacrylate, butyl methacrylate, dimethylaminoethyl methacrylate, and vinyl acetate.

The following, for example, can be used as the vinyl compound having a substituted silyl group: vinyltrichlorosilane, vinyltrimethoxysilane, vinyltriethoxysilane, vinylmethyldimethoxysilane, and vinyltris(2-methoxyethoxy)silane.

An ester bond-bearing silane-modified vinyl resin can be obtained by the vinyl polymerization of the preceding, while other components may also be polymerized in order to adjust the properties.

Examples in this regard are styrene; substituted styrenes such as vinyltoluene; substituted vinylnaphthalenes; as well as ethylene, propylene, vinyl methyl ether, vinyl ethyl ether, vinyl methyl ketone, butadiene, isoprene, maleic acid, and maleate esters.

There are no particular limitations on the method for producing the vinyl polymer, and known methods can be used. A single one of these compounds may be used or a combination of a plurality of these compounds may be used.

In addition, from the standpoint of the charge rise performance in high-temperature, high-humidity environments, the resin A preferably contains the ester bond in the main chain, e.g., a silane-modified polyester resin. For example, the resin A may contain a polyester segment. This makes it easier to control the ester bond content.

The resin A preferably contains the resin represented by the following formula (1) and more preferably is the resin represented by the following formula (1).

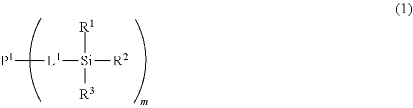

(In formula (1), P¹ represents an ester bond-bearing macromolecular segment; L¹ represents a single bond or a divalent linking group; R¹ to R³ each independently represent a hydrogen atom, halogen atom, alkyl group, alkoxy group, hydroxy group, or aryl group; and m represents a positive integer. When m is equal to or greater than 2, the plurality of L¹'s may be the same as one another or may differ from each other; the plurality of R¹'s may be the same as one another or may differ from each other; the plurality of R²'s may be the same as one another or may differ from each other; and the plurality of R³'s may be the same as one another or may differ from each other.)

With the resin represented by formula (1), the silicon atom (Si) is present in the resin in side chain or terminal position and charge transfer can proceed easily. The aforementioned charge rise performance is further improved by this.

From the standpoint of the charge rise performance in high-temperature, high-humidity environments, the ester bond content in the resin A is at least 12.0 mass % and is preferably at least 15.0 mass %. On the other hand, the upper limit on this content is not particularly limited, but is preferably not more than 70.0 mass % and is more preferably not more than 60.0 mass %. Any combination of these may be used for the numerical value range here.

The silicon atom content in the resin A is preferably from 0.02 mass % to 10.00 mass %, more preferably from 0.10 mass % to 5.00 mass %, and still more preferably from 0.15 mass % to 2.00 mass %.

The resin represented by formula (1) can bring about additional improvements in the charge rise performance in high-temperature, high-humidity environments.

R¹ to R³ in formula (1) each independently represent a hydrogen atom, halogen atom, alkyl group, alkoxy group, hydroxy group, or aryl group.

The number of carbons in the alkyl group is preferably 1 to 4 and more preferably 1 to 3.

The number of carbons in the alkoxy group is preferably 1 to 4 and more preferably 1 to 3.

The number of carbons in the aryl group is preferably 6 to 12 and more preferably 6 to 10.

Among the preceding, at least one of the R¹ to R³ in formula (1) preferably represents an alkoxy group or hydroxy group. More preferably, R¹ to R³ in formula (1) each independently represent an alkoxy group or hydroxy group.

Such a constitution provides an improved hot offset resistance. This is thought to be due to the following: the alkoxysilyl group or silanol group present in the resin forms a siloxane bond due to heating at the time of fixing and the viscosity of the resin increases, and as a result the generation of delamination within the toner, which is the cause of hot offset, is suppressed.

In order to have at least one of R¹ to R³ in formula (1) be a hydroxy group, for example, a resin in which at least one of R¹ to R³ is an alkoxy group may be subjected to hydrolysis in order to convert the alkoxy group to the hydroxy group.

Any method may be used for hydrolysis, and the following procedure is an example.

A resin in which at least one of R¹ to R³ in formula (1) is an alkoxy group is dissolved or suspended in a suitable solvent (this may be a polymerizable monomer), the pH is adjusted to acidity using acid or alkali, and mixing and hydrolysis are carried out.

Hydrolysis may also be carried out during toner particle production.

P¹ in formula (1) should have an ester bond-bearing macromolecular segment (for example, a polymer segment), but is not otherwise particularly limited. Examples here are a polyester segment, ester bond-bearing vinyl polymer segment (for example, a styrene-acrylic acid copolymer segment), polyurethane segment, polycarbonate segment, ester bond-bearing phenolic resin segment, and ester bond-bearing polyolefin segment.

The charge rise performance in high-temperature, high-humidity environments is further improved when, among the preceding, P¹ contains a polyester segment.

L¹ represents a single bond or a divalent linking group, wherein the divalent linking group can be exemplified by alkylene groups, phenylene groups, and the structures given below by formulas (2), (3), (4), and (5). The alkylene groups and phenylene groups may be substituted with a substituent. Such a substituent can be exemplified by the methyl group, alkoxy groups, hydroxy group, halogen atoms, and combinations of the preceding. The alkylene group preferably has 1 to 12 carbons and more preferably 1 to 4 carbons.

The structure represented by the following formula (2) is preferred from the standpoint of the tape peeling performance.

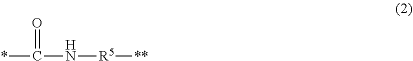

(In formula (2), * represents a bonding segment to P¹; ** represents a bonding segment to the Si; and R⁵ represents a single bond, alkylene group, or arylene group.)

The number of carbons in the alkylene group is preferably 1 to 12 and more preferably 1 to 3.

The number of carbons in the arylene group is preferably 6 to 12 and more preferably 6 to 10.

The use of this structure was found to provide an improvement in the tape peeling performance post-toner fixing. This is hypothesized to be due to a high affinity between the amide bond and the hydroxy groups present in the cellulose that constitutes the fibers of the paper that is the fixing media.

Further descriptions are provided for embodiments of the case in which P¹ in formula (1) contains a polyester segment; however, this should not be construed as a limitation thereto.

The polyester segment refers to a macromolecular segment that has the ester bond (—CO—O—) in a main chain repeat unit. An example here is a condensation polymer structure between a polyhydric alcohol (alcohol component) and a polyvalent carboxylic acid (carboxylic acid component). Specific examples are macromolecular segments in which a structure represented by the following formula (6) (structure derived from a dicarboxylic acid) is bonded, with the formation of an ester bond, with at least one structure (structure derived from a diol) selected from the group consisting of the formulas (7) to (9) given below. This may also be a macromolecular segment in which a structure represented by the formula (10) given below (structure derived from a compound having a carboxy group and a hydroxy group in the single molecule) is bonded with the formation of an ester bond.

The incorporation, as a constituent component in the polyester segment, of a monomer unit derived from an aromatic ring-bearing compound is preferred from the standpoint of the charge rise performance in high-temperature, high-humidity environments. Examples are embodiments in which the content in the polyester segment of the structure given by the following formula (8) is at least 50 mass %, at least 60 mass %, or at least 70 mass % and is not more than 85 mass %.

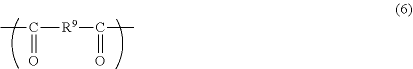

(In formula (6), R⁹ represents an alkylene group, alkenylene group, or arylene group.)

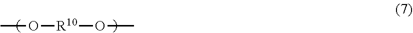

(In formula (7), R¹⁰ represents an alkylene group or a phenylene group.)

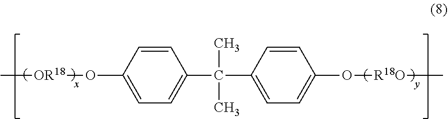

(In formula (8), R¹⁸ represents an ethylene group or propylene group. x and y are each an integer with a value equal to or greater than 0, and the average value of x+y is 2 to 10.)

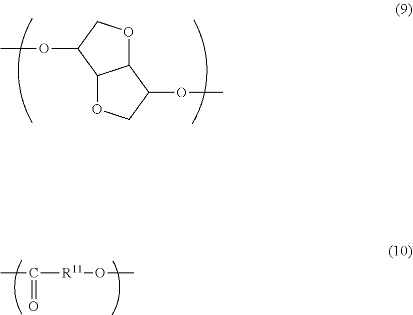

(In formula (10), R¹¹ represents an alkylene group or alkenylene group.)

The alkylene group (preferably having 1 to 12 carbons) represented by R⁹ in formula (6) can be exemplified by the following:

methylene group, ethylene group, trimethylene group, propylene group, tetramethylene group, hexamethylene group, neopentylene group, heptamethylene group, octamethylene group, nonamethylene group, decamethylene group, undecamethylene group, dodecamethylene group, 1,3-cyclopentylene, 1,3-cyclohexylene, and 1,4-cyclohexylene group.

The alkenylene group (preferably having 2 to 4 carbons) represented by R⁹ in formula (6) can be exemplified by the vinylene group, propenylene group, and 2-butenylene group.

The arylene group (preferably having 6 to 12 carbons) represented by R⁹ in formula (6) can be exemplified by the 1,4-phenylene group, 1,3-phenylene group, 1,2-phenylene group, 2,6-naphthylene group, 2,7-naphthylene group, and 4,4′-biphenylene group.

R⁹ in formula (6) may be substituted by a substituent. Examples of the substituent in such a case are the methyl group, halogen atoms, carboxy group, trifluoromethyl group, and their combinations.

The alkylene group (preferably having 1 to 12 carbons) represented by R¹⁰ in formula (7) can be exemplified by the following:

methylene group, ethylene group, trimethylene group, propylene group, tetramethylene group, hexamethylene group, neopentylene group, heptamethylene group, octamethylene group, nonamethylene group, decamethylene group, undecamethylene group, dodecamethylene group, 1,3-cyclopentylene, 1,3-cyclohexylene, and 1,4-cyclohexylene group.

The phenylene group represented by R¹⁰ in formula (7) can be exemplified by the 1,4-phenylene group, 1,3-phenylene group, and 1,2-phenylene group.

R¹⁰ in formula (7) may be substituted by a substituent. Examples of the substituent in such a case are the methyl group, alkoxy groups, hydroxy group, halogen atoms, and their combinations.

The alkylene group (preferably having 1 to 12 carbons) represented by R¹¹ in formula (10) can be exemplified by the following:

methylene group, ethylene group, trimethylene group, propylene group, tetramethylene group, hexamethylene group, neopentylene group, heptamethylene group, octamethylene group, nonamethylene group, decamethylene group, undecamethylene group, dodecamethylene group, and 1,4-cyclohexylene group.

The alkenylene group (preferably having 2 to 40 carbons) represented by R¹¹ in formula (10) can be exemplified by the following:

vinylene group, propenylene group, butenylene group, butadienylene group, pentenylene group, hexenylene group, hexadienylene group, heptenylene group, octenylene group, decenylene group, octadecenylene group, eicosenylene group, and triacontenylene group.

These alkenylene groups may have any of the following structures: straight chain, branched, and cyclic. The position of the double bond may be at any location, and at least one or more double bonds may be present.

R¹¹ in formula (10) may be substituted by a substituent. Examples of the substituent in such a case are alkyl groups, alkoxy groups, hydroxy groups, halogen atoms, and combinations of the preceding.

The polyvalent carboxylic acid (carboxylic acid component), on the other hand, can be exemplified by the following carboxylic acids:

dibasic carboxylic acids such as maleic acid, fumaric acid, citraconic acid, itaconic acid, glutaconic acid, phthalic acid, isophthalic acid, terephthalic acid, 2,6-naphthalenedicarboxylic acid, succinic acid, adipic acid, sebacic acid, azelaic acid, and malonic acid. Preferred among these are maleic acid, fumaric acid, and terephthalic acid.

The at least tribasic carboxylic acids can be exemplified by the following:

1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and Empol trimer acid and the anhydrides and lower alkyl esters of the preceding.

A single one of these dibasic carboxylic acids may be used or two or more may be used in combination, and a single one of these at least tribasic carboxylic acids may be used or two or more may be used in combination.

The incorporation, as a constituent component in the polyester segment, of a monomer unit derived from an at least trihydric polyhydric alcohol or an at least tribasic polyvalent carboxylic acid is preferred from the standpoint of the charge rise performance in high-temperature, high-humidity environments. Examples here are embodiments in which the content in the polyester segment of monomer unit derived from an at least trihydric polyhydric alcohol or an at least tribasic polyvalent carboxylic acid is at least 0.1 mass %, at least 0.3 mass %, or at least 0.5 mass %, and not more than 5.0 mass %.

As previously indicated, the structures represented by the following formulas (2), (3), (4), and (5) are examples of the L¹ in formula (1), but there is no particular limitation to these.

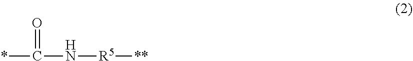

(R⁵ in formula (2) represents a single bond, an alkylene group, or an arylene group. The (*) represents a bonding segment to the P¹ in formula (1), and the (**) represents a bonding segment to the silicon atom (Si) in formula (1).)

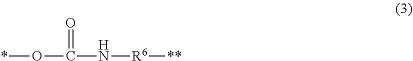

(R⁶ in formula (3) represents a single bond, an alkylene group, or an arylene group. The (*) represents a bonding segment to the P¹ in formula (1), and the (**) represents a bonding segment to the silicon atom (Si) in formula (1).)

For R⁶, the number of carbons in the alkylene group is preferably 1 to 12 and more preferably 1 to 3.

The number of carbons in the arylene group is preferably 6 to 12 and more preferably 6 to 10.

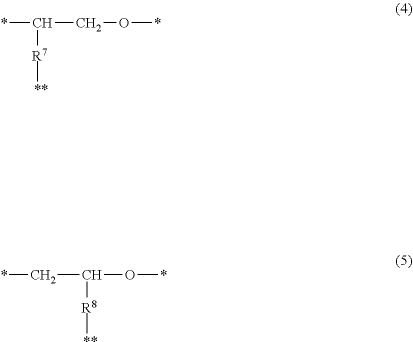

(R⁷ and R⁸ in formulas (4) and (5) each independently represent a single bond, an alkylene group, an arylene group, or an oxyalkylene group. The (*) represents a bonding segment to the P¹ in formula (1), and the (**) represents a bonding segment to the silicon atom (Si) in formula (1).)

For R⁷ and R⁸, the number of carbons in the alkylene group is preferably 1 to 12 and more preferably 1 to 3.

The number of carbons in the arylene group is preferably 6 to 12 and more preferably 6 to 10.

The number of carbons in the oxyalkylene group is preferably 1 to 12 and more preferably 1 to 3.

The structure represented by formula (2) is a divalent linking group that contains an amide bond.

This linking group is not limited to the case of formation by reaction. In the case of the formation of the linking group by reaction to produce the resin represented by formula (1), for example, a carboxy group-bearing compound may be reacted with an aminosilane compound (for example, a compound containing the amino group and an alkoxysilyl group, a compound containing the amino group and an alkylsilyl group, and so forth).

The aminosilane compound is not particularly limited, but can be exemplified by γ-aminopropyltriethoxysilane, γ-aminopropyltrimethoxysilane, N-β-(aminoethyl)-γ-aminopropyltrimethoxysilane, N-β-(aminoethyl)-γ-aminopropylmethyldimethoxysilane, N-phenyl-γ-aminopropyltriethoxysilane, N-phenyl-γ-aminopropyltrimethoxysilane, N-β-(aminoethyl)-γ-aminopropyltriethoxysilane, N-6-(aminohexyl)-3-aminopropyltrimethoxysilane, 3-aminopropyltrimethylsilane, and 3-aminopropylsilicon.

The alkylene group encompassed by R⁵ in formula (2) may be an alkylene group that contains the —NH— group.

The structure given by formula (3) is a urethane bond-bearing divalent linking group.

This linking group is not limited to the case of formation by reaction. In the case of the formation of the linking group by reaction to produce the resin represented by formula (1), for example, formation may be carried out by reacting a hydroxy group-bearing compound with an isocyanatosilane compound (for example, a compound containing the isocyanate group and an alkoxysilyl group, a compound containing the isocyanate group and an alkylsilyl group, and so forth).

The isocyanatosilane compound is not particularly limited, but can be exemplified by 3-isocyanatopropyltrimethoxysilane, 3-isocyanatopropylmethyldimethoxysilane, 3-isocyanatopropyldimethylmethoxysilane, 3-isocyanatopropyltriethoxysilane, 3-isocyanatopropylmethyldiethoxysilane, 3-isocyanatopropyldimethylethoxysilane, and 3-isocyanatopropyltrimethylsilane.

The structures represented by formulas (4) and (5) are divalent linking groups that contain bonds that are grafted to the ester bond in the polymer.

These linking groups are not limited to the case of formation by reaction. In the case of the formation of the linking group by reaction to produce the resin represented by formula (1), for example, formation may be carried out by an insertion reaction of an epoxy group-bearing silane compound. The insertion reaction of the epoxy group-bearing silane compound is the reaction indicated below.

Included here is a step of carrying out the insertion reaction of the epoxy group of an epoxy group-bearing silane compound into an ester bond present in the polymer main chain.

The insertion reaction referenced here is the reaction described as, for example, “Addition Reaction of Epoxy Compounds with Esters and Its Application for Polymer Syntheses”, Journal of Synthetic Organic Chemistry, Japan, Volume 49, Number 3, page 218, 1991.

The following formula (A) shows the mechanism of this reaction as a simple model formula.

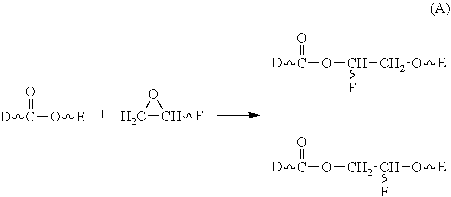

(In formula (A), D and E represent constituent portions of the polymer, and F represents the constituent portion of the epoxy group-bearing silane compound excluding the epoxy moiety.)

Two types of compounds are possible arising from α-cleavage and β-cleavage in the ring-opening of the epoxy group in formula (A), but both represent a mode of epoxy group insertion into the ester bond in the polymer, i.e., a mode for the grafting, into the polymer segment, of the constituent portion of the epoxy group-bearing silane compound excluding the epoxy moiety.

The epoxy group-bearing silane compound is not particularly limited, but can be exemplified by β-(3,4-epoxycyclohexyl)ethyltrimethoxysilane, γ-glycidoxypropyltrimethoxysilane, γ-glycidoxypropylmethyldiethoxysilane, and 5,6-epoxyhexyltrimethylsilane.

From the standpoint of the charge rise performance in high-temperature, high-humidity environments, the resin A, which has an ester bond and has a substituted or unsubstituted silyl group in the molecule, preferably contains, as a constituent component in the resin, a monomer unit derived from an aromatic ring-bearing compound. This is because the aromatic ring has a high electron density originating with the π-bonds and the generation of polarization is facilitated by resonance with electrons in the p-orbitals that the elements bonded to the aromatic ring possess.

Due to this, the charge rise performance is further increased because the aromatic ring can also contribute to the charge transfer that has been produced between the ester bond and silicon atom.

The resin A preferably also contains as a constituent component a monomer unit derived from an at least trihydric polyhydric alcohol or an at least tribasic polyvalent carboxylic acid.

This increases, by virtue of the monomer unit derived from the at least trihydric polyhydric alcohol or the at least tribasic polyvalent carboxylic acid, the number of terminals within each individual molecule because the macromolecular chain forming the resin assumes a branched structure, and the amount of silicon atom that can be introduced into a single molecule can then be increased through the bonding at the molecular terminals of a segment having a substituted or unsubstituted silyl group.

As a result, a more uniform distribution of the silicon atoms within the resin A can be brought about and an increase can be brought about in the number of ester bond/silicon atom pairs present in the vicinity of the toner surface and capable of diffusing the charge at the toner surface during charging. It is hypothesized that an excellent charge rise performance is obtained as a consequence.

The weight-average molecular weight (Mw) of the resin A, or the weight-average molecular weight (Mw) of the resin represented by formula (1), is preferably from 3000 to 100000 and is more preferably from 3000 to 60000. Having the weight-average molecular weight be in the indicated range provides the toner with a better storability and a better low-temperature fixability.

The content of the resin A in the total resin in the toner particle is preferably from 1.0 mass % to 100.0 mass % and is more preferably from 1.0 mass % to 10.0 mass %.

The toner particle may contain a non-resin-A resin.

This non-resin-A resin (also referred to herebelow as the binder resin; however, when a non-resin-A resin is not present in the toner particle, the resin A is then the binder resin.) will be described.

There are no particular limitations on the binder resin, and examples here are the known binder resins used in toners.

The following are examples: homopolymers of aromatic vinyl compounds and their substituted forms, e.g., styrene and vinyltoluene; copolymers of aromatic vinyl compounds, e.g., styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-dimethylaminoethyl acrylate copolymer, styrene-methyl methacrylate copolymer, styrene-ethyl methacrylate copolymer, styrene-butyl methacrylate copolymer, styrene-dimethylaminoethyl methacrylate copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-maleic acid copolymer, and styrene-maleate ester copolymer; homopolymers of aliphatic vinyl compounds and their substituted forms, e.g., ethylene and propylene; vinyl resins such as polyvinyl acetate, polyvinyl propionate, polyvinyl benzoate, polyvinyl butyrate, polyvinyl formate, and polyvinyl butyral; vinyl ether resins; vinyl ketone resins; acrylic polymers; methacrylic polymers; silicone resins; polyester resins; polyamide resins; epoxy resins; phenolic resins; rosin; modified rosin; and terpene resins. A single one of these may be used by itself or a combination of a plurality may be used.

The aromatic vinyl compounds and their substituted forms can be exemplified by the following:

styrene and styrene derivatives, e.g., styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene.

The polymerizable monomer for formation of acrylic polymers can be exemplified by acrylic polymerizable monomers, e.g., acrylic acid, methyl acrylate, ethyl acrylate, n-propyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate.

The polymerizable monomer for formation of methacrylic polymers can be exemplified by methacrylic polymerizable monomers, e.g., methacrylic acid, methyl methacrylate, ethyl methacrylate, n-propyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate.

Condensation polymers between the hereafter-exemplified carboxylic acid components and alcohol components can be used as the polyester resin. The carboxylic acid component can be exemplified by terephthalic acid, isophthalic acid, phthalic acid, fumaric acid, maleic acid, cyclohexanedicarboxylic acid, and trimellitic acid. The alcohol component can be exemplified by bisphenol A, hydrogenated bisphenols, ethylene oxide adducts on bisphenol A, propylene oxide adducts on bisphenol A, glycerol, trimethylolpropane, and pentaerythritol.

The polyester resin may be a urea group-containing polyester resin. Preferably the carboxy groups, e.g., in terminal position and so forth, of the polyester resin are not capped.

The binder resin may have polymerizable functional groups with the goal of enhancing the viscosity change of the toner at high temperatures. The polymerizable functional group can be exemplified by the vinyl group, isocyanate group, epoxy group, amino group, carboxy group, and hydroxy group.

Among the preceding, styrene-acrylic acid copolymers, as typified in particular by styrene-butyl acrylate, are preferred from the standpoint of the developing characteristics and fixing performance. The method for producing the polymer is not particularly limited and known methods can be used.

The toner particle may contain a wax. There are no particular limitations on this was, and the following are examples: aliphatic hydrocarbon waxes such as low molecular weight polyethylene, low molecular weight polypropylene, microcrystalline wax, Fischer-Tropsch wax, and paraffin wax; the oxides of aliphatic hydrocarbon waxes, e.g., oxidized polyethylene wax, and their block copolymers; waxes in which the main component is a fatty acid ester, e.g., carnauba wax and montanic acid ester wax, and waxes provided by the partial or complete deacidification of a fatty acid ester, e.g., deacidified carnauba wax; saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralkyl alcohols, behenyl alcohol, carnaubyl alcohol, ceryl alcohol, and melissyl alcohol; polyhydric alcohols such as sorbitol; fatty acid amides such as linoleamide, oleamide, and lauramide; saturated fatty acid bisamides such as methylenebisstearamide, ethylenebiscapramide, ethylenebislauramide, and hexamethylenebisstearamide; unsaturated fatty acid amides such as ethylenebisoleamide, hexamethylenebisoleamide, N,N′-dioleyladipamide, and N,N′-dioleylsebacamide; aromatic bisamides such as m-xylenebisstearamide and N,N′-distearylisophthalamide; fatty acid metal salts (generally known as metal soaps) such as calcium stearate, calcium laurate, zinc stearate, and magnesium stearate; waxes provided by grafting an aliphatic hydrocarbon wax using a vinyl monomer such as styrene or acrylic acid; partial esters between a fatty acid and a polyhydric alcohol, such as behenyl monoglyceride; and hydroxy group-containing methyl ester compounds obtained, e.g., by the hydrogenation of plant oils. A single one of these waxes may be used or a combination of two or more may be used.

The aliphatic alcohol for ester wax formation can be exemplified by 1-hexanol, 1-heptanol, 1-octanol, 1-nonanol, 1-decanol, undecyl alcohol, lauryl alcohol, myristyl alcohol, 1-hexadecanol, stearyl alcohol, arachidyl alcohol, behenyl alcohol, and lignoceryl alcohol. The aliphatic carboxylic acids can be exemplified by pentanoic acid, hexanoic acid, heptanoic acid, octanoic acid, nonanoic acid, decanoic acid, lauric acid, myristic acid, palmitic acid, stearic acid, arachidic acid, behenic acid, and lignoceric acid.

The wax content, considered per 100.0 mass parts of the binder resin or polymerizable monomer, is preferably from 0.5 mass parts to 20.0 mass parts.

Colorant

The toner may include a colorant. The colorant is not particularly limited, and known colorants can be used.

Examples of yellow pigments include yellow iron oxide and condensed azo compounds such as Navels Yellow, Naphthol Yellow S, Hansa Yellow G, Hansa Yellow 10G, Benzidine Yellow G, Benzidine Yellow GR, Quinoline Yellow Lake, Permanent Yellow NCG, Tartrazine Lake, and the like, isoindolinone compounds, anthraquinone compounds, azo metal complexes, methine compounds, and allylamide compounds. Specific examples are presented hereinbelow.

C. I. Pigment Yellow 12, 13, 14, 15, 17, 62, 74, 83, 93, 94, 95, 109, 110, 111, 128, 129, 147, 155, 168, 180.

Examples of orange pigments are presented below.

Permanent Orange GTR, Pyrazolone Orange, Vulcan Orange, Benzidine Orange G, Indanthrene Brilliant Orange RK, and Indathrene Brilliant Orange GK.

Examples of red pigments include Indian Red, condensation azo compounds such as Permanent Red 4R, Lithol Red, Pyrazolone Red, Watching Red calcium salt, Lake Red C, Lake Red D, Brilliant Carmine 6B, Brilliant Carmine 3B, Eosin Lake, Rhodamine Lake B, Alizarin Lake and the like, diketopyrrolopyrrole compounds, anthraquinone compounds, quinacridone compounds, basic dye lake compounds, naphthol compounds, benzimidazolone compounds, thioindigo compounds, perylene compounds. Specific examples are presented hereinbelow.

C. I. Pigment Red 2, 3, 5, 6, 7, 23, 48:2, 48:3, 48:4, 57:1, 81:1, 122, 144, 146, 166, 169, 177, 184, 185, 202, 206, 220, 221, 254.

Examples of blue pigments include copper phthalocyanine compounds and derivatives thereof such as Alkali Blue Lake, Victoria Blue Lake, Phthalocyanine Blue, metal-free Phthalocyanine Blue, partial Phthalocyanine Blue chloride, Fast Sky Blue, Indathrene Blue BG and the like, anthraquinone compounds, basic dye lake compound and the like. Specific examples are presented hereinbelow.

C. I. Pigment Blue 1, 7, 15, 15:1, 15:2, 15:3, 15:4, 60, 62, 66.

Examples of purple pigments include Fast Violet B and Methyl Violet Lake.

Examples of green pigments include Pigment Green B, Malachite Green Lake, and Final Yellow Green G. Examples of white pigments include zinc white, titanium oxide, antimony white and zinc sulfide.

Examples of black pigments include carbon black, aniline black, non-magnetic ferrites, magnetite, and those which are colored black by using the abovementioned yellow colorant, red colorant and blue colorant. These colorants can be used singly or in a mixture, or in the form of a solid solution.

If necessary, the colorant may be surface-treated with a substance which does not inhibit polymerization.

The amount of the colorant is preferably from 1.0 parts by mass to 15.0 parts by mass with respect to 100.0 parts by mass of the binder resin or the polymerizable monomer.

The toner particle may contain a charge control agent. A known charge control agent can be used as this charge control agent, while a charge control agent that provides a fast triboelectric charging speed and that can maintain a defined and stable triboelectric charge amount is preferred. When the toner particle is produced by a polymerization method, a charge control agent that exercises little polymerization inhibition and that is substantially free of material soluble in the aqueous medium is preferred.

Charge control agents comprise charge control agents that control toner to negative charging and charge control agents that control toner to positive charging.

The following are examples of charge control agents that control toner to negative charging:

monoazo metal compounds; acetylacetone-metal compounds; metal compounds of aromatic oxycarboxylic acids, aromatic dicarboxylic acids, oxycarboxylic acids, and dicarboxylic acids; aromatic oxycarboxylic acids, aromatic monocarboxylic acids, and aromatic polycarboxylic acids and their metal salts, anhydrides, and esters; phenol derivatives such as bisphenol; urea derivatives; metal-containing salicylic acid compounds; metal-containing naphthoic acid compounds; boron compounds; quaternary ammonium salts; calixarene; and resin-type charge control agents.

The following, on the other hand, are examples of charge control agents that control toner to positive charging:

nigrosine and nigrosine modifications by, e.g., fatty acid metal salts; guanidine compounds; imidazole compounds; quaternary ammonium salts such as tributylbenzylammonium 1-hydroxy-4-naphthosulfonate and tetrabutylammonium tetrafluoroborate, and their onium salt analogues, such as phosphonium salts, and their lake pigments; triphenylmethane dyes and their lake pigments (the laking agent is exemplified by phosphotungstic acid, phosphomolybdic acid, phosphomolybdotungstic acid, tannic acid, lauric acid, gallic acid, ferricyanides, and ferrocyanides); metal salts of higher fatty acids; and resin-type charge control agents.

A single one of these charge control agents may be used or combinations of two or more may be used. Among these charge control agents, metal-containing salicylic acid compounds are preferred and metal-containing salicylic acid compounds in which the metal is aluminum or zirconium are particularly preferred.

The amount of addition of the charge control agent, per 100.0 mass parts of the binder resin, is preferably from 0.1 mass parts to 20.0 mass parts and is more preferably from 0.5 mass parts to 10.0 mass parts.

A known means can be used for the method of producing the toner particle. Examples here are dry production methods, i.e., kneading pulverization methods, and wet production methods, i.e., suspension polymerization methods, dissolution suspension methods, emulsion aggregation methods, and emulsion polymerization and aggregation methods. The use of a wet method is preferred from the standpoints of sharpening the particle size distribution of the toner particle, improving the average circularity of the toner particle, and generating a core-shell structure.

For example, when the toner particle is produced by a kneading pulverization method, the resin A and optionally a binder resin, wax, colorant, charge control agent, and other additives are thoroughly mixed using a mixer, e.g., a Henschel mixer, ball mill, and so forth. After this, the toner particle is obtained by melt-kneading using a heated kneader, such as a hot roll, kneader, or extruder, to disperse or dissolve the various materials, and by a cooling and solidification step, a pulverization step, a classification step, and optionally a surface treatment step.

A known pulverization apparatus, e.g., a mechanical impact system, jet system, and so forth, may be used in the pulverization step. With regard to the sequence of the classification step and the surface treatment step, either may go before the other. The classification step preferably uses a multi-grade classifier based on productivity considerations.

Toner particle production by the suspension polymerization method, which is a wet production method, is described in the following.

An example of toner particle production using the suspension polymerization method is described in the following, but this should not be taken to mean that the present invention is thereby limited.

In the suspension polymerization method, the resin A and the polymerizable monomer for formation of the binder resin are dissolved or dispersed to uniformity using a disperser such as a ball mill or ultrasound disperser to obtain a polymerizable monomer composition (step of preparing a polymerizable monomer composition).

This polymerizable monomer can be exemplified by the polymerizable monomers provided as examples of the polymerizable monomer for formation of the aforementioned vinyl copolymers. Wax, colorant, charge control agent, crosslinking agent, polymerization initiator, and other additives may be added on an optional basis to the polymerizable monomer composition.

A crosslinking agent may be added on an optional basis during polymerization of the polymerizable monomer in order to control the molecular weight of the binder resin. Mainly a compound having two or more polymerizable double bonds is used as the crosslinking agent. Examples are aromatic divinyl compounds such as divinylbenzene and divinylnaphthalene; carboxylate esters containing two double bonds, such as ethylene glycol diacrylate, diethylene glycol diacrylate, triethylene glycol diacrylate, tetraethylene glycol diacrylate, neopentyl glycol diacrylate, 1,3-butanediol diacrylate, 1,3-butylene glycol diacrylate, 1,4-butanediol diacrylate, 1,5-pentanediol diacrylate, 1,6-hexanediol diacrylate, the diacrylates of polyethylene glycol #200, #400, and #600, dipropylene glycol diacrylate, polypropylene glycol diacrylate, polyester-type diacrylates (MANDA, Nippon Kayaku Co., Ltd.), and crosslinking agents provided by changing the acrylate in the preceding to methacrylate; divinyl compounds such as divinylaniline, divinyl ether, divinyl sulfide, and divinyl sulfone; and compounds having three or more vinyl groups. A single one of these may be used or a mixture of two or more may be used.

The amount of addition of the crosslinking agent is preferably from 0.1 mass parts to 15.0 mass parts per 100 mass parts of the polymerizable monomer.

The polymerizable monomer composition is then introduced into a previously prepared aqueous medium and droplets of the polymerizable monomer composition are formed in the desired toner particle size using a high-shear stirrer or a disperser (granulation step).

The aqueous medium in the granulation step preferably contains a dispersion stabilizer in order to suppress toner particle coalescence during the production sequence, control the particle size of the toner particle, and sharpen the particle size distribution.

The dispersion stabilizers can be generally categorized into polymers, which generate a repulsive force through steric hindrance, and sparingly water-soluble inorganic compounds, which support dispersion stabilization through an electrostatic repulsive force. Fine particles of a sparingly water-soluble inorganic compound, because they can be dissolved by acid or alkali, are advantageously used because they can be easily removed by dissolution by washing with acid or alkali after polymerization.

When the dispersion stabilizer is a sparingly water-soluble inorganic compound, the use is preferred of a dispersion stabilizer that contains any of the following: magnesium, calcium, barium, zinc, aluminum, and phosphorus. The dispersion stabilizer more preferably contains any of the following: magnesium, calcium, aluminum, and phosphorus. Specific examples are as follows:

magnesium phosphate, tricalcium phosphate, aluminum phosphate, zinc phosphate, magnesium carbonate, calcium carbonate, magnesium hydroxide, calcium hydroxide, aluminum hydroxide, calcium metasilicate, calcium sulfate, barium sulfate, and hydroxyapatite. When such a sparingly water-soluble inorganic dispersing agent is used, it may be used as such, or, in order to obtain even finer particles, use may be made of inorganic dispersing agent particles that have been produced in the aqueous medium. Using the case of tricalcium phosphate as an example, an aqueous sodium phosphate solution may be mixed with an aqueous calcium chloride solution under high-speed stirring to produce water-insoluble calcium phosphate, thus enabling a more uniform and finer dispersion.

An organic compound, for example, polyvinyl alcohol, gelatin, methyl cellulose, methyl hydroxypropyl cellulose, ethyl cellulose, the sodium salt of carboxymethyl cellulose, and starch, may also be used in combination in said dispersion stabilizer. These dispersion stabilizers are preferably used at from 0.1 mass parts to 20.0 mass parts per 100 mass parts of the polymerizable monomer.

A surfactant may also be used at from 0.1 mass parts to 10.0 mass parts per 100 mass parts of the polymerizable monomer in order to microtine-size these dispersion stabilizers. Specifically, a commercial nonionic, anionic, or cationic surfactant can be used. For example, the use is preferred of sodium dodecyl sulfate, sodium tetradecyl sulfate, sodium pentadecyl sulfate, sodium octyl sulfate, sodium oleate, sodium laurate, potassium stearate, or calcium oleate.

The polymerizable monomer present in the polymerizable monomer composition is polymerized, after the granulation step or while carrying out the granulation step, with the temperature set preferably to from 50° C. to 90° C. to obtain a toner particle dispersion (polymerization step).

During the polymerization step, a stirring operation sufficient to provide a uniform temperature distribution in the vessel is preferably carried out. When a polymerization initiator is added, this addition may be carried out using any timing and for any required length of time. In addition, with the goal of obtaining a desired molecular weight distribution, the temperature may be raised in the latter half of the polymerization reaction, and, in order to remove, e.g., unreacted polymerizable monomer and by-products, from the system, a portion of the aqueous medium may be distilled off by a distillation process in the latter half of the reaction or after the completion of the reaction. The distillation process is carried out at normal pressure or under reduced pressure.

The polymerization initiator used in the suspension polymerization method preferably has a half-life in the polymerization reaction of from 0.5 hour to 30 hours. A polymer having a maximum between molecular weights of 5000 and 50000 can be obtained when the polymerization reaction is carried out using an amount of addition of from 0.5 mass parts to 20 mass parts per 100 mass parts of the polymerizable monomer. Oil-soluble initiators are generally used as the polymerization initiator. The following are examples:

azo compounds, e.g., 2,2′-azobisisobutyronitrile, 2,2′-azobis-2,4-dimethylvaleronitrile, 1,1′-azobis(cyclohexane-1-carbonitrile), and 2,2′-azobis-4-methoxy-2,4-dimethylvaleronitrile, and peroxide initiators such as acetyl cyclohexylsulfonyl peroxide, diisopropyl peroxycarbonate, decanoyl peroxide, lauroyl peroxide, stearoyl peroxide, propionyl peroxide, acetyl peroxide, tert-butyl peroxy-2-ethylhexanoate, benzoyl peroxide, tert-butyl peroxyisobutyrate, cyclohexanone peroxide, methyl ethyl ketone peroxide, dicumyl peroxide, tert-butyl hydroperoxide, di-tert-butyl peroxide, tert-butyl peroxypivalate, and cumene hydroperoxide.

A water-soluble initiator may be co-used on an optional basis for the polymerization initiator, and examples thereof are as follows:

ammonium persulfate, potassium persulfate, 2,2′-azobis(N,N′-dimethyleneisobutyroamidine) hydrochloride, 2,2′-azobis(2-aminodinopropane) hydrochloride, azobis(isobutylamidine) hydrochloride, sodium 2,2′-azobisisobutyronitrilesulfonate, ferrous sulfate, or hydrogen peroxide.

A single one of these polymerization initiators may be used by itself or two or more may be used in combination. A chain transfer agent, polymerization inhibitor, and so forth may also be added and used in order to control the degree of polymerization of the polymerizable monomer.

The particle diameter of the toner particle is preferably a weight-average particle diameter of from 3.0 μm to 10.0 μm from the standpoint of obtaining a high-definition and high-resolution image. The weight-average particle diameter of the toner particle can be measured using the pore electrical resistance method. For example, measurement can be performed using a “Coulter Counter Multisizer 3” (Beckman Coulter, Inc.).

The toner particle dispersion provided by going through the polymerization step is transferred to a filtration step that performs solid-liquid separation of the toner particle from the aqueous medium.

The solid-liquid separation for obtaining the toner particle from the resulting toner particle dispersion can be carried out using an ordinary filtration method. This is preferably following by additional washing by, e.g., reslurrying or washing with wash water, in order to remove foreign material that could not previously be removed from the toner particle surface.

After thorough washing has been carried out, a toner cake is obtained by carrying out another solid-liquid separation. The toner particle is subsequently obtained by drying using a known drying means and as necessary separating out, by classification, particle fractions that have a non-spec particle diameter. When this is done, the separated particle fractions having a non-spec particle diameter may be re-used in order to improve the final yield.

The obtained toner particle may optionally be made into toner by adding, e.g., an external additive, and mixing in order to attach the external additive to the surface. For example, the use of an external additive facilitates control of, e.g., the flowability, charging performance, cleaning performance, and so forth.

The external additive can be exemplified by inorganic oxide fine particles composed of, e.g., silica fine particles, alumina fine particles, titanium oxide fine particles, and so forth; inorganic stearic acid compound fine particles, e.g., aluminum stearate fine particles, zinc stearate fine particles, and so forth; and inorganic titanic acid compound fine particles, e.g., strontium titanate, zinc titanate, and so forth.

Either of the following, for example, can be used as the silica fine particles: dry silica fine particles, also known as dry silica, which are produced by the vapor-phase oxidation of a silicon halide, and so-called wet silica fine particles, which are produced from, e.g., water glass.

In addition, in the case of dry silica fine particles, composite fine particles of silica and another metal oxide may also be obtained by the use of another metal halide, e.g., aluminum chloride, titanium chloride, and so forth, in combination with the silicon halide compound in the production step.

These inorganic fine particles have preferably been subjected to a surface treatment with, for example, a silane coupling agent, titanium coupling agent, higher fatty acid, silicone oil, silicone varnish, or various modified silicone varnishes. A single surface treatment agent may be used or two or more may be used in combination. This surface treatment supports adjustment of the charge amount on the toner, improvements in the heat-resistant storability, and improvements in the environmental stability. The BET specific surface area of the external additive is preferably from 10 m²/g to 450 m²/g.

The BET specific surface area can be determined according to the BET method (preferably the BET multipoint method) using a cryogenic gas adsorption procedure based on a dynamic constant pressure procedure. For example, using a specific surface area analyzer (product name: Gemini 2375 Ver. 5.0, Shimadzu Corporation), the BET specific surface area (m²/g) can be calculated by measurement carried out using the BET multipoint method and adsorption of nitrogen gas to the sample surface.

The content of the external additive in the toner, expressed per 100 mass parts of the toner particle, is preferably from 0.05 mass parts to 10.00 mass parts and more preferably from 0.1 mass parts to 5.0 mass parts. A single external additive may be used by itself or two or more may be used in combination. A known procedure can be used for mixing the external additive. For example, mixing may be carried out using a Henschel mixer.

The toner can be used as a magnetic or nonmagnetic one-component developer, but it may be also mixed with a carrier and used as a two-component developer.

As the carrier, magnetic particles composed of conventionally known materials such as metals such as iron, ferrites, magnetite and alloys of these metals with metals such as aluminum and lead can be used. Among them, ferrite particles are preferable. Further, a coated carrier obtained by coating the surface of magnetic particles with a coating agent such as a resin, a resin dispersion type carrier obtained by dispersing magnetic fine powder in a resin, or the like may be used as the carrier.

The volume average particle diameter of the carrier is preferably from 15 μm to 100 and more preferably from 25 μm to 80 μm.

The methods used to measure the properties pertaining to the toner are described in the following.

### Method for Extracting the Resin A from the Toner Particle

Extraction of the resin A in the toner particle is carried out by performing separation by solvent gradient elution on an extract obtained using tetrahydrofuran (THF). The preparative method is given in the following.

10.0 g of the toner particle is weighed out and is introduced into an extraction thimble (No. 84, Toyo Rosha Kaisha, Ltd.), and this is set into a Soxhlet extractor. Extraction is performed for 20 hours using 200 mL of THF as the solvent, and the solvent is then removed from the extract to yield a solid that is the THF-soluble matter. Resin A is contained in the THF-soluble matter. This procedure is performed a plurality of times to obtain the required amount of THF-soluble matter.

Gradient preparative HPLC (LC-20AP High-Performance Gradient Preparative System, Shimadzu Corporation; 50 mm∅×250 mm SunFire Preparative Column, Waters Corporation) is used for the solvent gradient elution procedure. The following are used: 30° C. for the column temperature, 50 mL/min for the flow rate, acetonitrile for the poor solvent in the mobile phase, and THF for the good solvent. 0.02 g of the THF-soluble matter yielded by the extraction is dissolved in 1.5 mL of THF and this is used as the sample for separation. A composition with 100% acetonitrile is used for the starting mobile phase; then, when 5 minutes have elapsed after sample injection, the percentage of THF is increased by 4% each minute; and the mobile phase composition at 25 minutes is 100% THF. Components can be separated by drying the obtained fractions to solidification. The resin A can thereby be obtained. Which fraction components are resin A can be determined by measurement of the silicon atom content and ¹³C-NMR measurement as described below.

Method for Measuring the Silicon Atom Content in the Resin A

An “Axios” wavelength-dispersive x-ray fluorescence analyzer (PANalytical B.V.) is used for the silicon atom content in the resin A. The “SuperQ ver. 4.0F” (PANalytical B.V.) software provided therewith is used in order to set the measurement conditions and analyze the measurement data.

Rh is used for the x-ray tube anode, and 24 kV and 100 mA are used, respectively, for the acceleration voltage and current.

A vacuum is used for the measurement atmosphere; 27 mm is used for the measurement diameter (collimator diameter); and 10 seconds is used for the measurement time. A proportional counter (PC) is used for the detector. The measurement is carried out using PET for the analyzing crystal; the count rate (unit: cps) of Si-Kα radiation observed at a diffraction angle (2θ) =109.08° is measured; and the determination is made using a calibration curve as described in the following.

The resin A (or the resin with formula (1)) may be used as such as the measurement sample, or the resin extracted from the toner particle using the aforementioned extraction method may be used as the measurement sample.

A “BRE-32” tablet compression molder (Maekawa Testing Machine Mfg. Co., Ltd.) is used to obtain the measurement pellet. 4 g of the measurement sample is introduced into a specialized aluminum compaction ring and is smoothed over, and a pellet is produced by molding to a thickness of 2 mm and a diameter of 39 mm by compression for 60 seconds at 20 MPa, and this pellet is used as the measurement pellet.

With regard to the pellets for construction of the calibration curve for the determination of content, SiO₂ (hydrophobic fumed silica) [product name: AEROSIL NAX50, specific surface area: 40±10 (m²/g), carbon content: 0.45 to 0.85%, from Nippon Aerosil Co., Ltd.] is added at 0.5 mass parts per 100 mass parts of a binder [product name: Spectro Blend, components: C 81.0, O 2.9, H 13.5, N 2.6 (mass %), chemical formula: C₁₉H₃₈ON, form: powder (44 μm), from the Rigaku Corporation]; thorough mixing is performed in a coffee mill; and a pellet is prepared by pellet molding. The same mixing and pellet molding procedure is used to prepare pellets using the SiO₂ at 5.0 mass parts and 10.0 mass parts, respectively.

A calibration curve in the form of a linear function is obtained by placing the obtained x-ray count rate on the vertical axis and the Si addition concentration for each calibration curve sample on the horizontal axis.

The count rate for Si-Kα radiation is then also measured for the measurement sample using the same procedure. The silicon atom content (mass %) is determined from the calibration curve that has been prepared.

Identification of the Structure of the Resin with Formula (1)

The macromolecular segment P¹, the L¹ segment, and the R¹ to R³ segments in the resin represented by formula (1) are identified using ¹H-NMR analysis, ¹³C-NMR analysis, ²⁹Si-NMR analysis, and FT-IR analysis. The resin A (or the resin with formula (1)) may be used as such as the measurement sample, or the resin extracted from the toner particle using the aforementioned extraction method may be used as the measurement sample.

When L¹ contains an amide bond as represented by formula (2), identification can be carried out by ¹H-NMR analysis. Specifically, identification can be carried out using the chemical shift value for the proton in the NH segment in the amide group, and the amount of amide group can be determined by calculation of the integration value.

In addition, when the R¹ to R³ in the resin represented by formula (1) contains an alkoxy group or hydroxy group, the valence with respect to the silicon atom of the alkoxy group or hydroxy group can be determined by the method described below under “Measurement Conditions for ²⁹Si-NMR (Solid State)”.

### Measurement Conditions for ²⁹Si-NMR (Solid State)

instrument: JNM-ECX500II, JEOL Resonance, Inc.
sample tube: 3.2 mm∅
sample size: 150 mg
measurement temperature: room temperature
pulse mode: CP/MAS
measurement nucleus frequency: 97.38 MHz (²⁹Si)
reference substance: DSS (external reference: 1.534 ppm)
sample spinning rate: 10 kHz
contact time: 10 ms
delay time: 2 s
number of scans: 2000 to 8000

This measurement makes it possible to obtain the abundance by peak separation/integration by curve fitting for the multiple silane components depending on the number of oxygen atoms bonded to the Si. Proceeding in this manner makes it possible to identify the valence with respect to the silicon atom of the alkoxy group or hydroxy group of the R¹ to R³ in the resin given by formula (1).

The structures of P¹, L¹, and R¹ to R³ in the resin represented by formula (1) can be determined by ¹³C-NMR (solid state) measurement. The measurement conditions are as follows.

### Measurement Conditions for ¹³C-NMR (Solid State)

instrument: JNM-ECX500II, JEOL Resonance, Inc.
sample tube: 3.2 mm0
sample size: 150 mg
measurement temperature: room temperature
pulse mode: CP/MAS
measurement nucleus frequency: 123.25 MHz (¹³C)
reference substance: adamantane (external reference: 29.5 ppm)
sample spinning rate: 20 kHz
contact time: 2 ms
delay time: 2 s
number of scans: 1024

Separation into various peaks depending on the species of P¹, L¹, and R¹ to R³ in formula (1) is performed and each are identified to determine the species of P¹, L¹, and R¹ to R³.

Method for Calculating the Ester Bond Content

The ester bond content in the resin A is calculated proceeding as follows using ¹³C-NMR. The measurement conditions are as follows. The resin A (or the resin with formula (1)) may be used as such as the measurement sample, or the resin extracted from the toner particle using the aforementioned extraction method may be used as the measurement sample.

instrument: AVANCE-600 FT-NMR, Bruker Corporation
sample size: 150 mg
measurement temperature: room temperature
measurement method: inversed-gated decoupling
solvent: 0.75 mL deuterochloroform
relaxation reagent: chromium(III) acetylacetonate
number of scans: 30000

Quantitation is performed by the internal reference method using the peak area appearing at 160.0 to 170.0 ppm, which originates with the ester bond.

Method for Measuring the Number-Average Molecular Weight (Mn) and the Weight-Average Molecular Weight (Mw)

The weight-average molecular weight (Mw) and number-average molecular weight (Mn) of the polymer, resin or toner particle are measured as follows using gel permeation chromatography (GPC).

First, the sample is dissolved in tetrahydrofuran (THF) for 24 hours at room temperature. The obtained solution is filtered using a “Sample Pretreatment Cartridge” (Tosoh Corporation) solvent-resistant membrane filter having a pore diameter of 0.2 μm to obtain a sample solution. The sample solution is adjusted to a concentration of THF-soluble component of approximately 0.8 mass %. Measurement is carried out under the following conditions using this sample solution.

instrument: HLC8120 GPC (detector: RI) (Tosoh Corporation)
column: 7-column train of Shodex KF-801, 802, 803, 804, 805, 806, and 807 (Showa Denko Kabushiki Kaisha)
eluent: tetrahydrofuran (THF)
flow rate: 1.0 mL/min
oven temperature: 40.0° C.
amount of sample injection: 0.10 mL

A molecular weight calibration curve constructed using polystyrene resin standards (product name “TSK Standard Polystyrene F-850, F-450, F-288, F-128, F-80, F-40, F-20, F-10, F-4, F-2, F-1, A-5000, A-2500, A-1000, A-500”, Tosoh Corporation) is used to determine the molecular weight of the sample.

### EXAMPLES

The present invention is more specifically described in the following using production examples and examples, but the present invention is in no way limited to or by these. Unless specifically indicated otherwise, the “parts” and “%” given in the examples and comparative examples are on a mass basis in all instances.

### Resin A (R-1) Production Example

Resin A (R-1) was produced using the following procedure.

The following materials were introduced into an autoclave fitted with a pressure reduction apparatus, water separation apparatus, nitrogen gas introduction apparatus, temperature measurement apparatus, and stirring apparatus and a reaction was run for 5 hours at 200° C. at normal pressure under a nitrogen atmosphere.
alcohol component : 80.8 parts (2.0 mol propylene oxide adduct on bisphenol A)
acid component 1 (terephthalic acid) : 15.8 parts
acid component 2 (isophthalic acid) : 15.8 parts
tetrabutoxytitanium : 0.2 parts

This was followed by the addition of the following materials and reaction for 3 hours at 220° C.
acid or alcohol component 3 (trimellitic acid) : 1.0 parts
tetrabutoxytitanium : 0.3 parts

The reaction was carried out for an additional 2 hours under a reduced pressure of 10 to 20 mmHg. The obtained resin was dissolved in chloroform; this solution was added dropwise into ethanol to perform reprecipitation; and a polyester was then obtained by filtration.

An amidation was carried out as described below between the amino group in an aminosilane and the carboxy group in the resulting polyester to produce the resin A (R-1).

100.0 parts of this polyester was dissolved in 400.0 parts of N,N-dimethylacetamide and the following materials were added and stirring was performed for 5 hours at normal temperature. After the completion of the reaction, the solution was added dropwise to methanol to carry out reprecipitation, and the resin A (R-1) was obtained by filtration.
silane compound (3-aminopropyltrimethoxysilane) : 1.3 parts
triethylamine : 2.4 parts
condensing agent (amidation agent) : 2.4 parts

[DMT-MM: 4-(4,6-dimethoxy-1,3,5-triazin-2-yl)-4-methylmorpholinium chloride]

The obtained resin A (R-1) had a weight-average molecular weight (Mw) of 19800, an ester bond content of 18.3 mass %, and a silicon atom content of 0.20 mass %. The structure and properties of the obtained (R-1) are given in Table 2-2 and Table 2-3.

### Resins (A) (R-5) to (R-10) and (R-103) Production Example

The alcohol component, acid component 1, acid component 2, acid or alcohol component 3, silane compound, triethylamine, and condensing agent in the Resin A (R-1) Production Example were changed to the components and/or number of parts given in Table 1 and Table 2-1. In addition, the reaction pressure, reaction temperature, and reaction time were adjusted as appropriate in order to obtain a lower molecular weight material or in order to obtain a higher molecular weight material. Resins A (R-5) to (R-10) and (R-103) were obtained otherwise proceeding in the same manner.

The structure and properties of the obtained (R-5) to (R-10) and (R-103) are given in Table 2-2 and Table 2-3.

### Resins A (R-11) to (R-25) Production Example

Resins A (R-11) to (R-25) were obtained proceeding as in the Resin A (R-1) Production Example, but changing the alcohol component, acid component 1, acid component 2, acid or alcohol component 3, silane compound, triethylamine, and condensing agent to the components and/or number of parts given in Table 1 and Table 2-1. The structure and properties of the obtained (R-11) to (R-25) are given in Table 2-2 and Table 2-3.

### Resin A (R-26) Production Example

Resin A (R-26) was produced using the following procedure.

The following materials were introduced into an autoclave fitted with a pressure reduction apparatus, water separation apparatus, nitrogen gas introduction apparatus, temperature measurement apparatus, and stirring apparatus and a reaction was run for 5 hours at 200° C. at normal pressure under a nitrogen atmosphere.
alcohol component : 93.2 parts (6.0 mol propylene oxide adduct on bisphenol A)
acid component 1 (terephthalic acid) : 11.2 parts
acid component 2 (isophthalic acid) : 11.2 parts
tetrabutoxytitanate : 0.2 parts

This was followed by the addition of the following material and reaction for 3 hours at 220° C.
tetrabutoxytitanate : 0.3 parts

The reaction was carried out for an additional 2 hours under a reduced pressure of 10 to 20 mmHg. The obtained resin was dissolved in chloroform; this solution was added dropwise into ethanol to perform reprecipitation; and a polyester was then obtained by filtration.

Resin A (R-26) was produced as follows by forming the urethane bond by reacting the hydroxy group in the obtained polyester with the isocyanate group in an isocyanatosilane.

100.0 parts of this polyester was dissolved in 1000.0 parts of chloroform and the following materials were added under a nitrogen atmosphere and stirring was performed for 5 hours at normal temperature. After the completion of the reaction, the solution was added dropwise to methanol to carry out reprecipitation, and the resin A (R-26) was obtained by filtration.
silane compound (3-isocyanatopropyltrimethylsilane) : 1.2 parts
titanium(IV) tetraisopropoxide : 1.0 parts

The structure and properties of the obtained (R-26) are given in Table 2-2 and Table 2-3.

### Resin A (R-27) Production Example

Resin A (R-27) was produced using the following procedure.

The following materials were introduced into an autoclave fitted with a pressure reduction apparatus, water separation apparatus, nitrogen gas introduction apparatus, temperature measurement apparatus, and stirring apparatus and a reaction was run for 5 hours at 200° C. at normal pressure under a nitrogen atmosphere.
alcohol component : 93.2 parts (6.0 mol propylene oxide adduct on bisphenol A)
acid component 1 (terephthalic acid) : 11.2 parts
acid component 2 (isophthalic acid) : 11.2 parts
tetrabutoxytitanate : 0.2 parts

This was followed by the addition of the following material and reaction for 3 hours at 220° C.
tetrabutoxytitanate : 0.3 parts

The reaction was carried out for an additional 2 hours under a reduced pressure of 10 to 20 mmHg. The obtained resin was dissolved in chloroform; this solution was added dropwise to ethanol to perform reprecipitation; and a polyester was then obtained by filtration.

Resin A (R-27), in which a linking group given by formula (4) or formula (5) was formed, was produced as follows by the insertion reaction, by the epoxy group in an epoxysilane, into the ester bond in the obtained polyester.

100.0 parts of this polyester was dissolved in 200.0 parts of anisole and the following materials were added under a nitrogen atmosphere and stirring was performed for 5 hours at approximately 140° C. After standing to cool, the reaction mixture was dissolved in 200 mL of chloroform and this was added dropwise to methanol to carry out reprecipitation, and the resin A (R-27) was obtained by filtration.
silane compound (5,6-epoxyhexyltrimethylsilane) : 1.3 parts
catalyst (tetrabutylphosphonium bromide) : 10.0 parts

The structure and properties of the obtained (R-27) are given in Table 2-2 and Table 2-3.

### Resins A (R-28) and (R-29) Production Example

Resins A (R-28) and (R-29) were obtained proceeding as in the Resin A (R-27) Production Example, but changing the alcohol component, acid component 1, acid component 2, and silane compound to the components and/or number of parts given in Table 1 and Table 2-1. The structure and properties of the obtained (R-28) and (R-29) are given in Table 2-2 and Table 2-3.

### Resin A (R-30) Production Example

Resin A (R-30) was produced using the following procedure.

100.0 parts of propylene glycol monomethyl ether was heated under nitrogen substitution and heating under reflux was carried out at a liquid temperature of at least 120° C. A mixture of the following materials was added to this dropwise over 3 hours.
styrene : 64.1 parts
butyl acrylate : 30.9 parts
acrylic acid : 5.0 parts
tert-butyl peroxybenzoate : 1.0 parts

(organoperoxide-type polymerization initiator, product name: Perbutyl Z, NOF Corporation)

After the completion of the dropwise addition, the solution was stirred for 3 hours; this was followed by distillation at normal pressure while heating until the liquid temperature reached 170° C. After the liquid temperature had reached 170° C., the pressure was reduced to 1 hPa and solvent removal was performed by distillation for 1 hour to obtain a solid resin material. This solid resin material was dissolved in tetrahydrofuran and was reprecipitated with n-hexane, and the precipitated solid was filtered off to obtain a styrene-acrylic acid copolymer.

An amidation was carried out as described below between the amino group in an aminosilane and the carboxy group in the resulting styrene-acrylic acid copolymer to produce the resin A (R-30).

100.0 parts of this styrene-acrylic acid copolymer was dissolved in 400.0 parts of N,N-dimethylacetamide and the following materials were added and stirring was performed for 5 hours at normal temperature. After the completion of the reaction, the solution was added dropwise to methanol to carry out reprecipitation, and the resin A (R-30) was obtained by filtration.
silane compound (3-aminopropyltrimethylsilane) : 1.0 parts
triethylamine : 2.7 parts
condensing agent : 2.7 parts

[DMT-MM: 4-(4,6-dimethoxy-1,3,5-triazin-2-yl)-4-methylmorpholinium chloride]

The obtained resin A (R-30) had a weight-average molecular weight (Mw) of 18100, an ester bond content of 12.2 mass %, and a silicon atom content of 0.22 mass %.

### Polyester Resin (A-1) Production Example

Polyester resin (A-1) was produced using the following procedure.

The following materials were introduced into an autoclave fitted with a pressure reduction apparatus, water separation apparatus, nitrogen gas introduction apparatus, temperature measurement apparatus, and stirring apparatus and a reaction was run for 5 hours at 200° C. at normal pressure under a nitrogen atmosphere.
2 mol propylene oxide adduct on bisphenol A : 39.6 parts
terephthalic acid : 8.0 parts
isophthalic acid : 7.6 parts
tetrabutoxytitanate : 0.1 parts

This was followed by the addition of 0.01 parts of trimellitic acid and 0.12 parts of tetrabutoxytitanate; reaction for 3 hours at 220° C.; and an additional reaction for 2 hours under a reduced pressure of 10 to 20 mmHg to obtain polyester (A-1). The obtained polyester resin (A-1) had a weight-average molecular weight (Mw) of 10200.

TABLE 1

| | | | | | | | Acid or | |
|---|---|---|---|---|---|---|---|---|
| | Alcohol | Number | Acid | Number | Acid | Number | alcohol | Number |
| | component | of parts | component 1 | of parts | component 2 | of parts | component 3 | of parts |
| R-1 | BPA—PO | 80.8 | Terephthalic acid | 15.8 | Isophthalic | 15.8 | Trimellitic | 1.0 |
| | 2.0 mol adduct | | | | acid | | acid | |
| R-5 | BPA—PO | 80.9 | Terephthalic acid | 16.1 | Isophthalic | 16.1 | Trimellitic | 0.4 |
| | 2.0 mol adduct | | | | acid | | acid | |
| R-6 | BPA—PO | 80.8 | Terephthalic acid | 16.0 | Isophthalic | 16.0 | Trimellitic | 0.7 |
| | 2.0 mol adduct | | | | acid | | acid | |
| R-7 | BPA—PO | 80.8 | Terephthalic acid | 15.8 | Isophthalic | 15.8 | Trimellitic | 1.0 |
| | 2.0 mol adduct | | | | acid | | acid | |
| R-8 | BPA—PO | 80.7 | Terephthalic acid | 15.7 | Isophthalic | 15.7 | Trimellitic | 1.4 |
| | 2.0 mol adduct | | | | acid | | acid | |
| R-9 | BPA—PO | 71.2 | Terephthalic acid | 19.1 | Isophthalic | 19.1 | Trimellitic | 2.5 |
| | 0.3 mol adduct | | | | acid | | acid | |
| R-10 | BPA—PO | 75.7 | Terephthalic acid | 17.7 | Isophthalic | 17.7 | Trimellitic | 1.5 |
| | 1.0 mol adduct | | | | acid | | acid | |
| R-11 | BPA—PO | 79.0 | Terephthalic acid | 16.7 | Isophthalic | 16.7 | Glycerol | 0.9 |
| | 2.0 mol adduct | | | | acid | | | |
| R-12 | BPA—PO | 81.0 | Terephthalic acid | 16.3 | Isophthalic | 16.3 | — | — |
| | 2.0 mol adduct | | | | acid | | | |
| R-13 | Lactic acid | 100.0 | — | — | — | — | — | — |
| R-14 | Propylene glycol— | 68.2 | Adipic acid | 43.2 | — | — | — | — |
| | PO 2.0 mol adduct | | | | | | | |
| R-15 | BPA | 69.5 | Terephthalic acid | 21.1 | Isophthalic | 21.1 | — | — |
| | | | | | acid | | | |
| R-16 | BPA—PO | 93.1 | Fumaric acid | 22.4 | — | — | — | — |
| | 3.0 mol adduct | | | | | | | |
| R-17 | BPA—PO | 87.6 | Terephthalic acid | 13.5 | Isophthalic | 13.5 | — | — |
| | 3.8 mol adduct | | | | acid | | | |
| R-18 | 1,3-propanediol— | 82.9 | 2,6-naphthalene- | 30.9 | — | — | — | — |
| | PO 7.0 mol adduct | | dicarboxylic acid | | | | | |
| R-19 | BPA—PO | 93.2 | Terephthalic acid | 11.2 | Isophthalic | 11.2 | — | — |
| | 6.0 mol adduct | | | | acid | | | |
| R-20 | BPA—PO | 93.2 | Terephthalic acid | 11.2 | Isophthalic | 11.2 | — | — |
| | 6.0 mol adduct | | | | acid | | | |
| R-21 | BPA—PO | 93.2 | Terephthalic acid | 11.2 | Isophthalic | 11.2 | — | — |
| | 6.0 mol adduct | | | | acid | | | |
| R-22 | BPA—PO | 93.2 | Terephthalic acid | 11.2 | Isophthalic | 11.2 | — | — |
| | 6.0 mol adduct | | | | acid | | | |
| R-23 | BPA—PO | 93.2 | Terephthalic acid | 11.2 | Isophthalic | 11.2 | — | — |
| | 6.0 mol adduct | | | | acid | | | |
| R-24 | BPA—PO | 93.2 | Terephthalic acid | 11.2 | Isophthalic | 11.2 | — | — |
| | 6.0 mol adduct | | | | acid | | | |
| R-25 | BPA—PO | 93.2 | Terephthalic acid | 11.2 | Isophthalic | 11.2 | — | — |
| | 6.0 mol adduct | | | | acid | | | |
| R-26 | BPA—PO | 93.2 | Terephthalic acid | 11.2 | Isophthalic | 11.2 | — | — |
| | 6.0 mol adduct | | | | acid | | | |
| R-27 | BPA—PO | 93.2 | Terephthalic acid | 11.2 | Isophthalic | 11.2 | — | — |
| | 6.0 mol adduct | | | | acid | | | |
| R-28 | BPA—PO | 81.0 | Terephthalic acid | 16.3 | Isophthalic | 16.3 | — | — |
| | 2.0 mol adduct | | | | acid | | | |
| R-29 | BPA—PO | 75.9 | Terephthalic acid | 18.4 | Isophthalic | 18.4 | — | — |
| | 1.0 mol adduct | | | | acid | | | |
| R-103 | BPA—PO | 67.3 | Terephthalic acid | 15.7 | Isophthalic | 15.7 | Trimellitic | 1.3 |
| | 2.0 mol adduct | | | | acid | | acid | |

In the table, BPA represents bisphenol A and PO represents propylene oxide.

TABLE 2-1

| | Silane compound | | | Condensing |
|---|---|---|---|---|
| | | Number | | agent |
| Resin A | | of | Triethylamine | (DMT-MM) |
| No. | Type | parts | (parts) | (parts) |
| R-1 | 3-aminopropyltrimethoxysilane | 1.3 | 2.4 | 2.4 |
| R-5 | 3-aminopropyltrimethoxysilane | 0.2 | 0.3 | 0.3 |
| R-6 | 3-aminopropyltrimethoxysilane | 0.6 | 1.1 | 1.1 |
| R-7 | 3-aminopropyltrimethoxysilane | 1.0 | 1.8 | 1.8 |
| R-8 | 3-aminopropyltrimethoxysilane | 3.2 | 5.9 | 5.9 |
| R-9 | 3-aminopropyltrimethoxysilane | 6.0 | 10.9 | 10.9 |
| R-10 | 3-aminopropyltrimethoxysilane | 13.8 | 25.2 | 25.2 |
| R-11 | 3-aminopropyltrimethoxysilane | 1.3 | 2.4 | 2.4 |
| R-12 | 3-aminopropyltrimethoxysilane | 1.3 | 2.4 | 2.4 |
| R-13 | 3-aminopropyltrimethoxysilane | 1.1 | 2.0 | 2.0 |
| R-14 | 3-aminopropyltrimethoxysilane | 1.3 | 2.3 | 2.3 |
| R-15 | 3-aminopropyltrimethoxysilane | 1.3 | 2.3 | 2.3 |
| R-16 | 3-aminopropyltrimethoxysilane | 1.3 | 2.4 | 2.4 |
| R-17 | 3-aminopropyltrimethoxysilane | 1.3 | 2.4 | 2.4 |
| R-18 | 3-aminopropyltrimethoxysilane | 1.3 | 2.4 | 2.4 |
| R-19 | 3-aminopropyltrimethoxysilane | 1.3 | 2.4 | 2.4 |
| R-20 | 3-aminopropyltriethoxysilane | 1.6 | 2.5 | 2.5 |
| R-21 | 3-aminopropylmethyldimethoxysilane | 1.2 | 2.4 | 2.4 |
| R-22 | 3-aminopropyldimethylmethoxysilane | 1.1 | 2.4 | 2.4 |
| R-23 | 3-aminopropyltrimethylsilane | 1.0 | 2.3 | 2.3 |
| R-24 | 11-aminoundecyltrimethylsilane | 1.8 | 2.5 | 2.5 |
| R-25 | aminophenyltrimethylsilane | 1.2 | 2.4 | 2.4 |
| R-26 | 3-isocyanatopropyltrimethylsilane | 1.2 | — | — |
| R-27 | 5,6-epoxyhexyltrimethylsilane | 1.3 | — | — |
| R-28 | 5,6-epoxyhexyltrimethylsilane | 43.8 | — | — |
| R-29 | 5,6-epoxyhexyltrimethylsilane | 74.8 | — | — |
| R-103 | — | — | — | — |

TABLE 2-2

| | Structure | | | | | | |
|---|---|---|---|---|---|---|---|
| Resin | | | | | | | R7 or |
| A No. | R1 | R2 | R3 | L1 | R5 | R6 | R8 |
| R-1 | —OMe | —OMe | —OMe | Formula (2) | —C₃H₆— | — | — |
| R-5 | —OMe | —OMe | —OMe | Formula (2) | —C₃H₆— | — | — |
| R-6 | —OMe | —OMe | —OMe | Formula (2) | —C₃H₆— | — | — |
| R-7 | —OMe | —OMe | —OMe | Formula (2) | —C₃H₆— | — | — |
| R-8 | —OMe | —OMe | —OMe | Formula (2) | —C₃H₆— | — | — |
| R-9 | —OMe | —OMe | —OMe | Formula (2) | —C₃H₆— | — | — |
| R-10 | —OMe | —OMe | —OMe | Formula (2) | —C₃H₆— | — | — |
| R-11 | —OMe | —OMe | —OMe | Formula (2) | —C₃H₆— | — | — |
| R-12 | —OMe | —OMe | —OMe | Formula (2) | —C₃H₆— | — | — |
| R-13 | —OMe | —OMe | —OMe | Formula (2) | —C₃H₆— | — | — |
| R-14 | —OMe | —OMe | —OMe | Formula (2) | —C₃H₆— | — | — |
| R-15 | —OMe | —OMe | —OMe | Formula (2) | —C₃H₆— | — | — |
| R-16 | —OMe | —OMe | —OMe | Formula (2) | —C₃H₆— | — | — |
| R-17 | —OMe | —OMe | —OMe | Formula (2) | —C₃H₆— | — | — |
| R-18 | —OMe | —OMe | —OMe | Formula (2) | —C₃H₆— | — | — |
| R-19 | —OMe | —OMe | —OMe | Formula (2) | —C₃H₆— | — | — |
| R-20 | —OEt | —OEt | —OEt | Formula (2) | —C₃H₆— | — | — |
| R-21 | —OMe | —OMe | —Me | Formula (2) | —C₃H₆— | — | — |
| R-22 | —OMe | —Me | —Me | Formula (2) | —C₃H₆— | — | — |
| R-23 | —Me | —Me | —Me | Formula (2) | —C₃H₆— | — | — |
| R-24 | —Me | —Me | —Me | Formula (2) | —C₁₁H₂₂— | — | — |
| R-25 | —Me | —Me | —Me | Formula (2) | —Ph— | — | — |
| R-26 | —Me | —Me | —Me | Formula (3) | — | —C₃H₆— | — |
| R-27 | —Me | —Me | —Me | Formula (4) | — | — | —C₄H₈— |
| | | | | or (5) | | | |
| R-28 | —Me | —Me | —Me | Formula (4) | — | — | —C₄H₈— |
| | | | | or (5) | | | |
| R-29 | —Me | —Me | —Me | Formula (4) | — | — | —C₄H₈— |
| | | | | or (5) | | | |
| R-103 | — | — | — | — | — | — | — |

In the table, R1, R2, R3, and L1 represent the R¹, R², R³, and L¹ in formula (1), and R5, R6, R7, and R8 respectively represent the R⁵, R⁶, R⁷, and R⁸ in formulas (2), (3), (4), and (5). In addition, —OMe represents the methoxy group; —OEt represents the ethoxy group; —Me represents the methyl group; and —Ph— represents the phenylene group.

TABLE 2-31

| | Properties | | | |
|---|---|---|---|---|
| | Weight-average | Ester bond | Silicon atom | |
| Resin A | molecular weight | content | content | |
| No. | Mw | (mass %) | (mass %) | |
| R-1 | 19800 | 18.3 | 0.20 | Example 1-4 |
| R-5 | 99900 | 18.5 | 0.03 | Example 5 |
| R-6 | 59800 | 18.4 | 0.09 | Example 6 |
| R-7 | 38400 | 18.3 | 0.15 | Example 7 |
| R-8 | 14800 | 17.9 | 0.48 | Example 8 |
| R-9 | 8000 | 21.9 | 0.87 | Example 9 |
| R-10 | 3000 | 18.4 | 1.87 | Example 10 |
| R-11 | 19800 | 17.8 | 0.20 | Example 11 |
| R-12 | 20200 | 18.3 | 0.20 | Example 12 |
| R-13 | 20400 | 60.3 | 0.19 | Example 13 |
| R-14 | 19900 | 28.7 | 0.20 | Example 14 |
| R-15 | 20000 | 24.2 | 0.20 | Example 15 |
| R-16 | 20100 | 18.0 | 0.20 | Example 16 |
| R-17 | 20000 | 15.0 | 0.20 | Example 17 |
| R-18 | 20200 | 13.1 | 0.20 | Example 18 |
| R-19 | 20100 | 12.3 | 0.20 | Example 19 |
| R-20 | 20100 | 12.3 | 0.20 | Example 20 |
| R-21 | 20000 | 12.3 | 0.20 | Example 21 |
| R-22 | 20000 | 12.3 | 0.20 | Example 22 |
| R-23 | 20000 | 12.3 | 0.20 | Example 23 |
| R-24 | 20100 | 12.2 | 0.20 | Example 24 |
| R-25 | 20000 | 12.3 | 0.20 | Example 25 |
| R-26 | 20000 | 12.3 | 0.20 | Example 26 |
| R-27 | 20000 | 12.3 | 0.20 | Example 27 |
| R-28 | 19000 | 13.0 | 4.90 | Example 28 |
| R-29 | 20300 | 12.2 | 6.90 | Example 29 |
| R-103 | 30000 | 18.5 | 0.00 | Comparative |
| | | | | Example 3 |

### Toner Particle 1 Production Example

### Production of Aqueous Medium 1

390.0 parts of deionized water and 14.0 parts of sodium phosphate (dodecahydrate) (RASA Industries, Ltd.) were introduced into a reactor and the temperature was held at 65° C. for 1.0 hour while purging with nitrogen.

An aqueous calcium chloride solution of 9.2 parts calcium chloride (dihydrate) dissolved in 10.0 parts of deionized water was introduced all at once while stirring at 12,000 rpm using a T. K. Homomixer (Tokushu Kika Kogyo Co., Ltd.) to prepare an aqueous medium containing a dispersion stabilizer.

10% hydrochloric acid was introduced into this aqueous medium to adjust the pH to 6.0 and provide aqueous medium 1.

### Polymerizable Monomer Composition 1 Production

| | |
|---|---|
| styrene | 60.0 parts |
| colorant (C. I. Pigment | 6.5 parts |
| Blue 15:3) | |

These materials were introduced into an attritor (Nippon Coke & Engineering Co., Ltd.) and dispersion was carried out for 5.0 hours at 220 rpm using zirconia particles with a diameter of 1.7 mm; this was followed by the removal of the zirconia particles to provide a dispersion 1 in which the colorant was dispersed.

The following materials were added to this dispersion 1.

| | |
|---|---|
| styrene | 20.0 parts |
| n-butyl acrylate | 20.0 parts |
| resin A(R-1) | 3.0 parts |
| polyester resin (A-1) | 5.0 parts |
| Fischer-Tropsch wax (melting | 7.0 parts |
| point: 78° C.) | |

This was then held at 65° C. and a polymerizable monomer composition 1 was prepared by dissolving and dispersing to uniformity at 500 rpm using a T. K. Homomixer.

### Granulation Step

While holding the temperature of aqueous medium 1 at 70° C. and the stirrer rotation rate at 12,000 rpm, the polymerizable monomer composition 1 was introduced into the aqueous medium 1 and 9.0 parts of the polymerization initiator t-butyl peroxypivalate was added. Granulation was performed for 10 minutes while maintaining 12,000 rpm with the stirrer.

### Polymerization Step

The high-speed stirrer was replaced with a stirrer equipped with a propeller impeller and polymerization was carried out for 5.0 hours while maintaining 70° C. and stirring at 150 rpm. An additional polymerization reaction was run by raising the temperature to 85° C. and heating for 2.0 hours to obtain toner base particle dispersion 1.

### Washing and Filtration Step

The pH was then adjusted to 1.5 with 1 mol/L hydrochloric acid; stirring was subsequently carried out for 1 hour; and filtration was performed while washing with deionized water to obtain a toner particle 1.

### Toner Particle 2 Production Example

### Resin Particle Dispersion Production

The following materials were weighed out and mixed and dissolved.

| | |
|---|---|
| styrene | 82.6 parts |
| n-butyl acrylate | 9.2 parts |
| acrylic acid | 1.3 parts |
| resin A (R-1) | 3.0 parts |
| hexanediol diacrylate | 0.4 parts |
| n-lauryl mercaptan | 3.2 parts |

A 10% aqueous solution of Neogen RK (DKS Co., Ltd.) was added to the resulting solution and dispersion was carried out. An aqueous solution of 0.15 parts of potassium persulfate dissolved in 10.0 parts of deionized water was added while gently stirring for 10 minutes. After substitution with nitrogen, an emulsion polymerization was run for 6.0 hours at a temperature of 70° C. After completion of the polymerization, the reaction solution was cooled to room temperature and deionized water was added to yield a resin particle dispersion having a solids concentration of 12.5% and a median diameter on a volume basis of 0.2 μm.

### Wax Particle Dispersion Production

The following materials were weighed out and mixed.

| | |
|---|---|
| ester wax (melting | 100.0 parts |
| point: 70 C.) | |
| Neogen RK (DKS Co., Ltd.) | 15.0 parts |
| deionized water | 385.0 parts |

These materials were dispersed for 1 hour using a JN100 wet jet mill (Jokoh Co., Ltd.) to yield a wax particle dispersion. The wax solids concentration in this wax particle dispersion was 20.0%.

### Colorant Particle Dispersion Production

The following materials were weighed out and mixed.

| | |
|---|---|
| colorant (C. I. Pigment | 100.0 parts |
| Blue 15:3) | |
| Neogen RK (DKS Co., Ltd.) | 15.0 parts |
| deionized water | 885.0 parts |

These materials were dispersed for 1 hour using a JN100 wet jet mill (Jokoh Co., Ltd.) to yield a colorant particle dispersion.

| | |
|---|---|
| resin particle dispersion | 160.0 parts |
| wax particle dispersion | 10.0 parts |
| colorant particle dispersion | 10.0 parts |
| magnesium sulfate | 0.2 parts |

These materials were dispersed using a homogenizer (Ultra-Turrax T50, IKA Works GmbH & Co. KG), followed by heating to 65° C. while stirring.

After stirring for 1.0 hour at 65° C. had been carried out, observation with an optical microscope confirmed the formation of aggregated particles having a number-average particle diameter of 6.0 μm.

To this was then added 2.2 parts of Neogen RK (DKS Co., Ltd.), followed by heating to 80° C. and stirring for 2.0 hours to obtain fused spherical toner base particles.

Cooling was carried out followed by filtration, and the separated solid was washed for 1.0 hour by stirring with 720.0 parts of deionized water. The toner particle-containing solution was filtered, and toner particle 2 was obtained by drying using a vacuum dryer.

### Toner Particle 3 Production Example

660.0 parts of deionized water and 25.0 parts of a 48.5% aqueous solution of sodium dodecyldiphenyl ether disulfonate were mixed, and an aqueous medium 2 was prepared by stirring at 10,000 rpm using a T. K. Homomixer.

The following materials were introduced into 500.0 parts of ethyl acetate and a solution was prepared by dissolving at 100 rpm using a propeller stirrer.

| | |
|---|---|
| styrene/butyl acrylate copolymer | 100.0 parts |
| (copolymerization mass ratio: 80/20) | |
| resin A (R-1) | 3.0 parts |
| polyester resin (A-1) | 5.0 parts |
| colorant (C. I. Pigment Blue 15:3) | 6.5 parts |
| Fischer-Tropsch wax (melting | 9.0 parts |
| point: 78° C.) | |

150.0 parts of aqueous medium 2 was introduced into a container; stirring was carried out at 12,000 rpm using a T. K. Homomixer; 100.0 parts of the aforementioned solution was added to this; and mixing was performed for 10 minutes to prepare an emulsion slurry.

100.0 parts of the emulsion slurry was subsequently introduced into a flask equipped with a degassing line, stirrer, and thermometer; the solvent was removed under reduced pressure for 12 hours at 30° C. while stirring at 500 rpm; and maturation was carried out for 4 hours at 45° C. to provide a solvent-removed slurry.

The solvent-removed slurry was subjected to filtration under reduced pressure; 300.0 parts deionized water was added to the resulting filter cake; mixing and redispersion were performed using a T. K. Homomixer (10 minutes at 12,000 rpm); and filtration was carried out.

The resulting filter cake was dried with a dryer for 48 hours at 45° C. followed by screening across a mesh with an aperture of 75 μm to provide toner particle 3.

### Toner Particle 4 Production Example

The following materials were introduced into a reactor fitted with a condenser, stirrer, and nitrogen introduction line.

| | |
|---|---|
| terephthalic acid | 29.0 parts |
| polyoxypropylene(2.2)-2,2-bis(4- | 80.0 parts |
| hydroxyphenyl)propane | |
| titanium dihydroxybis(triethanolaminate) | 0.1 parts |

This was followed by heating to 200° C. and reaction for 9 hours while introducing nitrogen and removing the evolved water. 5.8 parts trimellitic anhydride was then added; heating to 170° C. was carried out; and a polyester resin (A-2) was produced by reaction for 3 hours.

In addition,

| | |
|---|---|
| low-density polyethylene (melting | 20.0 parts |
| point: 100° C.) | |
| styrene | 64.0 parts |
| n-butyl acrylate | 13.5 parts |
| acrylonitrile | 2.5 parts |

were introduced into an autoclave and the interior was substituted with nitrogen and holding at 180° C. was then carried out while heating and stirring.

50.0 parts of a 2.0% xylene solution of t-butyl hydroperoxide was continuously added dropwise over 4.5 hours to the system, and, after cooling, the solvent was separated and removed to yield a graft polymer in which a copolymer was grafted on polyethylene.

| | |
|---|---|
| polyester resin (A-2) | 100.0 parts |
| resin A (R-1) | 3.0 parts |
| paraffin wax (melting point: 75° C.) | 5.0 parts |
| graft polymer | 5.0 parts |
| C. I. Pigment Blue 15:3 | 5.0 parts |

These materials were thoroughly mixed using an FM mixer (Model FM-75, Nippon Coke & Engineering Co., Ltd.) followed by melt-kneading with a twin-screw kneader (Model PCM-30, Ikegai Ironworks Corporation) set to a temperature of 100° C.

The resulting kneaded material was cooled and was coarsely pulverized to 1 mm and below using a hammer mill to yield a coarse pulverizate.

Then, a finely pulverized material of about 5 μm was obtained from this coarse pulverizate using a Turbo Mill from Turbo Kogyo Co., Ltd. (T-250: RSS rotor/SNB liner).

The fines and coarse powder were subsequently cut using a Coanda effect-based multi-grade classifier to obtain a toner particle 4.

### Toner Particles 5 to 29 Production Example

Toner particles 5 to 29 were each produced proceeding as in the Toner Particle 1 Production Example, but changing resin A (R-1) to resins A (R-5) to (R-29), respectively.

### Toner Particle 30 Production Example

Toner particle 30 was produced proceeding as in the Toner Particle 1 Production Example, but changing resin A (R-1) to resin A (R-30) and changing to the material amounts given below.

| | |
|---|---|
| styrene (rather than 60.0 parts | 58.0 parts |
| for dispersion 1) | |
| n-butyl acrylate | 19.0 parts |
| polyester resin (A-1) | 8.0 parts |

### Toner Particle 31 Production Example

Toner particle 31 was produced proceeding as in the Toner Particle 1 Production Example, but changing to 1.1 parts of vinyltrichlorosilane and 3.0 parts of divinylbenzene in place of the resin A (R-1) and changing to the material amounts indicated below.

| | |
|---|---|
| styrene | 45.0 parts |
| (rather than 60.0 parts for dispersion 1) | |
| styrene | 14.6 parts |
| (rather than 20.0 parts for polymerizable | |
| monomer composition 1) | |
| n-butyl acrylate | 36.3 parts |
| divinylbenzene | 3.0 parts |
| vinyltrichlorosilane | 1.1 parts |
| polyester resin (A-1) | 8.0 parts |

In this production example, the resin constituting toner particle 31 corresponds to the resin A. The resin A in toner particle 31 had a weight-average molecular weight (Mw) of 82400, an ester bond content of 12.8 mass %, and a silicon atom content of 0.20 mass %.

### Comparative Toner Particle 1 Production Example

### Polymerizable Monomer Composition 101 Production

| | |
|---|---|
| styrene | 60.0 parts |
| colorant (C. I. Pigment | 6.5 parts |
| Blue 15:3) | |

These materials were introduced into an attritor (Nippon Coke & Engineering Co., Ltd.) and dispersion was carried out for 5.0 hours at 220 rpm using zirconia particles with a diameter of 1.7 mm; this was followed by the removal of the zirconia particles to provide a dispersion 101 in which the colorant was dispersed.

The following materials were added to this dispersion 101.

| | |
|---|---|
| styrene | 20.0 parts |
| n-butyl acrylate | 20.0 parts |
| vinyltrichlorosilane | 1.2 parts |
| polyester resin (A-1) | 8.0 parts |
| Fischer-Tropsch wax (melting | 7.0 parts |
| point: 78° C.) | |

This was then held at 65° C. and a polymerizable monomer composition 101 was prepared by dissolving and dispersing to uniformity at 500 rpm using a T. K. Homomixer.

### Granulation Step

While holding the temperature of aqueous medium 1 at 70° C. and the stirrer rotation rate at 12,000 rpm, the polymerizable monomer composition 101 was introduced into the aqueous medium 1 and 9.0 parts of the polymerization initiator t-butyl peroxypivalate was added. Granulation was performed for 10 minutes while maintaining 12,000 rpm with the stirrer.

### Polymerization Step

The high-speed stirrer was replaced with a stirrer equipped with a propeller impeller and polymerization was carried out for 5.0 hours while maintaining 70° C. and stirring at 150 rpm. An additional polymerization reaction was run by raising the temperature to 85° C. and heating for 2.0 hours to obtain toner base particle dispersion 101.

### Washing and Filtration Step

The pH was then adjusted to 1.5 with 1 mol/L hydrochloric acid; stirring was subsequently carried out for 1 hour; and filtration was performed while washing with deionized water to obtain a toner particle 101 (comparative toner particle 1).

In this production example, the resin constituting toner particle 101 (comparative toner particle 1) corresponds to the resin A. The resin A in toner particle 101 (comparative toner particle 1) had a weight-average molecular weight (Mw) of 87300, an ester bond content of 7.2 mass %, and a silicon atom content of 0.21 mass %.

### Comparative Toner Particle 2 Production Example

Comparative toner particle 2 was obtained proceeding as in the Comparative Toner Particle 1 Production Example, but without adding the vinyltrichlorosilane.

### Comparative Toner Particle 3 Production Example

Comparative toner particle 3 was obtained proceeding as in the Toner Particle 4 Production Example, but changing resin A (R-1) to (R-103).

### Toner 1 Production Example

Toner 1 was obtained by mixing, using a Henschel mixer (Mitsui Miike Chemical Engineering Machinery Co., Ltd.), 100 parts of toner particle 1 with 0.6 parts of hydrophobic silica fine particles having a BET value of 200 m²/g and a number-average primary particle diameter of 8 nm.

### Toners 2 to 31 and Comparative Toners 1 to 3 Production Example

Toners 2 to 31 and comparative toners 1 to 3 were obtained proceeding as in the Toner 1 Production Example, but changing toner particle 1 to toner particle 2 to 31 and comparative toner particle 1 to 3.

### Evaluation of the Charge Rise Performance in a High-Temperature, High-Humidity Environment

The following evaluation was performed in a high-temperature, high-humidity environment (30° C., 80% RH).

19.0 g of F813-300 magnetic carrier (Powdertech Co., Ltd.) and 1.0 g of the toner to be evaluated were introduced into a lidded 50-mL plastic bottle; two of these were prepared.

Shaking was performed for 2 minutes and 10 minutes, respectively, at a speed of 4 roundtrips per second using a shaker (YS-LD, Yayoi Co., Ltd.) to prepare two-component developers.

0.200 g of the two-component developer for measurement of the triboelectric charge amount is introduced into a metal measurement container 2 having a 500-mesh screen 3 (25 μm aperture) at the bottom, as shown in the FIGURE, and a metal lid 4 is applied. The mass of the entire measurement container 2 at this point is measured to give W1 (g).

Suction is then drawn through a suction port 7 with a suction device 1 (the part in contact with the measurement container 2 is at least an insulator), and the pressure at a vacuum gauge 5 is brought to 50 mmAq by adjustment with an airflow control valve 6. The toner is suctioned and removed in this state for 1 minute.

The potential at an electrometer 9 at this point is indicated in volts (V). Here, 8 is a capacitor, and the capacitance is C (μF). The mass of the overall measurement container after suction is measured to give W2 (g). The triboelectric charge amount on the toner is calculated using the following formula.

triboelectric charge amount (mC/kg)=(C×V)/(W1−W2)

The value of “[triboelectric charge amount after shaking for 2 minutes”/“triboelectric charge amount after shaking for 10 minutes]×100” was calculated, and this result was taken to be the charge rise performance and was evaluated using the following criteria. The results of the evaluation are given in Table 3.

A: the charge rise performance is at least 90%
B: the charge rise performance is at least 80%, but less than 90%
C: the charge rise performance is at least 70%, but less than 80%
D: the charge rise performance is at least 60%, but less than 70%
E: the charge rise performance is less than 60%

### Evaluation of the Tape Peelability

A color laser printer (HP Color LaserJet 3525dn, Hewlett-Packard Enterprise Development LP) modified to enable adjustment of the developing bias was used as the image-forming apparatus, and FOX RIVER BOND paper (110 g/m²), which has a relatively large surface unevenness and areal weight, was used as the fixing media.

A line image is used for the image in the evaluation. By increasing the amount of toner on the image by establishing a high image density by swinging the developing bias, and by using a heavy paper having a large amount of surface unevenness, melting of the toner in the depressed portions in the paper and in the lower layer region of the toner layer during the fixing step can be made more difficult, thus enabling a rigorous evaluation of peeling.

The evaluation procedure is as follows. The image-forming apparatus was first held overnight in a low-temperature, low-humidity environment (15° C., 10% RH). When a low temperature is used for the evaluation environment, it is then more difficult for the fixing unit to warm up and a rigorous evaluation can be carried out.

Using the FOX RIVER BOND paper, a horizontal line image is then printed with the developing bias adjusted to give a line width of 180 μm. After standing for 1 hour in the low-temperature, low-humidity environment, a polypropylene tape (Klebeband 19 mm×10 mm, from tesa SE) was applied to the horizontal line image and was gradually peeled off. After peeling, the image was visually and microscopically inspected and was evaluated in accordance with the following evaluation criteria. The results of the evaluation are given in Table 3.

A: no loss
B: slight loss is observed, but is not recognized by visual inspection
C: loss that can also be recognized visually is observed to a slight degree
D: there is loss that can be recognized visually and locations occur where a line has been cut
E: numerous line cuts occur

Evaluation of the Low-Temperature Fixability

A color laser printer (HP Color LaserJet 3525dn, Hewlett-Packard Enterprise Development LP) having a detached fixing unit was prepared as the image-forming apparatus, and HP Laser Jet 90 (90 g/m², Hewlett-Packard Enterprise Development LP) was used as the fixation media.

The toner was removed from the cyan cartridge and the toner to be evaluated was loaded in its place. Using the loaded toner, an unfixed toner image (toner laid-on level: 0.9 mg/cm²) 2.0 cm long and 15.0 cm wide was then formed on the fixation media at the region 1.0 cm from the leading edge with respect to the paper feed direction. The detached fixing unit was then modified to enable the fixation temperature and process speed to be adjustable, and this was used to carry out a fixing test on the unfixed image.

With the process speed set to 300 mm/s and operating in a normal-temperature, normal-humidity environment (23° C., 60% RH), the unfixed image was fixed at each temperature, starting from an initial temperature of 145° C. and increasing the set temperature sequentially in 5° C. increments. The results of the evaluation are given in Table 3.

The evaluation criteria for the low-temperature fixability are given below. The lower limit fixation temperature is the lower limit temperature at which cold offset behavior (behavior in which a portion of the toner ends up attaching to the fixing unit) and/or blistering (swelling of the fixed image) is not observed.

A: the lower limit fixation temperature is equal to or less than 150° C.
B: the lower limit fixation temperature is at least 155° C. and not more than 160° C.
C: the lower limit fixation temperature is at least 165° C. and not more than 170° C.
D: the lower limit fixation temperature is at least 175° C. and not more than 180° C.
E: the lower limit fixation temperature is equal to or greater than 185° C.

Evaluation of the Hot Offset Resistance

A fixing test on an unfixed image was run proceeding as in the Evaluation of the Low-Temperature Fixability.

With the process speed set to 300 mm/s and operating in a normal-temperature, normal-humidity environment (23° C., 60% RH), the unfixed image was fixed at each temperature, starting from an initial temperature of 195° C. and increasing the set temperature sequentially in 5° C. increments. The results of the evaluation are given in Table 3.

The evaluation criteria for the hot offset resistance are given below. The upper limit fixation temperature is the upper limit temperature at which the phenomenon of attachment of the melted toner to the fixing roller (hot offset) is not observed.

A: the upper limit fixation temperature is equal to or greater than 230° C.
B: the upper limit fixation temperature is at least 220° C. and not more than 225° C.
C: the upper limit fixation temperature is at least 210° C. and not more than 215° C.
D: the upper limit fixation temperature is at least 200° C. and not more than 205° C.
E: the upper limit fixation temperature is equal to or less than 195° C.

TABLE 3

| | | | | | Low- | | | |
|---|---|---|---|---|---|---|---|---|
| Ex- | | Charge rise | | Tape | temperature | | Hot offset | |
| ample | Toner | performance | | peelability | fixability | | resistance | |
| No. | No. | % | Rank | Rank | ° C. | Rank | ° C. | Rank |
| 1 | 1 | 94% | A | A | 145° C. | A | 230° C. | A |
| 2 | 2 | 93% | A | A | 145° C. | A | 230° C. | A |
| 3 | 3 | 91% | A | A | 145° C. | A | 230° C. | A |
| 4 | 4 | 90% | A | A | 150° C. | A | 230° C. | A |
| 5 | 5 | 84% | B | A | 155° C. | B | 230° C. | A |
| 6 | 6 | 92% | A | A | 145° C. | A | 230° C. | A |
| 7 | 7 | 93% | A | A | 145° C. | A | 230° C. | A |
| 8 | 8 | 94% | A | A | 145° C. | A | 230° C. | A |
| 9 | 9 | 94% | A | A | 145° C. | A | 230° C. | A |
| 10 | 10 | 95% | A | A | 150° C. | A | 230° C. | A |
| 11 | 11 | 92% | A | A | 150° C. | A | 230° C. | A |
| 12 | 12 | 83% | B | A | 150° C. | A | 230° C. | A |
| 13 | 13 | 78% | C | A | 150° C. | A | 230° C. | A |
| 14 | 14 | 77% | C | A | 150° C. | A | 230° C. | A |
| 15 | 15 | 87% | B | A | 150° C. | A | 230° C. | A |
| 16 | 16 | 85% | B | A | 150° C. | A | 230° C. | A |
| 17 | 17 | 82% | B | A | 150° C. | A | 230° C. | A |
| 18 | 18 | 79% | C | A | 150° C. | A | 230° C. | A |
| 19 | 19 | 76% | C | A | 150° C. | A | 230° C. | A |
| 20 | 20 | 77% | C | A | 150° C. | A | 230° C. | A |
| 21 | 21 | 75% | C | A | 150° C. | A | 225° C. | B |
| 22 | 22 | 73% | C | A | 150° C. | A | 220° C. | B |
| 23 | 23 | 72% | C | A | 150° C. | A | 215° C. | C |
| 24 | 24 | 75% | C | A | 155° C. | B | 210° C. | C |
| 25 | 25 | 74% | C | A | 155° C. | B | 210° C. | C |
| 26 | 26 | 71% | C | B | 160° C. | B | 210° C. | C |
| 27 | 27 | 70% | C | B | 160° C. | B | 210° C. | C |
| 28 | 28 | 75% | C | B | 165° C. | C | 215° C. | C |
| 29 | 29 | 77% | C | B | 165° C. | C | 215° C. | C |
| 30 | 30 | 70% | C | B | 170° C. | C | 210° C. | C |
| 31 | 31 | 71% | C | C | 170° C. | C | 210° C. | C |
| C.E. 1 | C. 1 | 63% | D | D | 175° C. | D | 210° C. | C |
| C.E. 2 | C. 2 | 58% | E | D | 175° C. | D | 210° C. | C |
| C.E. 3 | C. 3 | 67% | D | C | 170° C. | C | 210° C. | C |

In the table, “C.E.” denotes “comparative example”, and “C.” denotes “comparison”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-083660, filed Apr. 25, 2019, which is hereby incorporated by reference herein in its entirety.

What is claimed is:

1. A toner comprising a toner particle that contains a resin A, wherein
the resin A contains an ester bond, and has a substituted or unsubstituted silyl group in a molecule thereof,
a substituent on the substituted silyl group is at least one selected from the group consisting of alkyl groups, alkoxy groups, hydroxy groups, aryl groups, and halogen atoms; and
a content of the ester bond in the resin A is at least 12.0 mass %.

2. The toner according to claim 1, wherein the resin A contains a resin represented by the following formula (1): 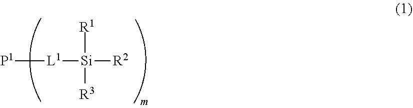
in formula (1), P¹ represents an ester bond-bearing macromolecular segment; L¹ represents a single bond or a divalent linking group; R¹ to R³ each independently represent a hydrogen atom, halogen atom, alkyl group, alkoxy group, hydroxy group, or aryl group; and m represents a positive integer; and
when m is equal to or greater than 2, the plurality of L¹'s may be the same as one another or may differ from each other; the plurality of R¹'s may be the same as one another or may differ from each other; the plurality of R²'s may be the same as one another or may differ from each other; and the plurality of R³'s may be the same as one another or may differ from each other.

3. The toner according to claim 2, wherein L¹ is the structure represented by the following formula (2): 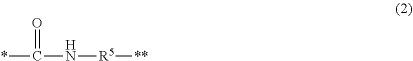
in formula (2), * represents a bonding segment to the P¹; ** represents a bonding segment to the Si; and R⁵ represents a single bond, alkylene group, or arylene group.

4. The toner according to claim 2, wherein at least one of R¹ to R³ represents an alkoxy group or a hydroxy group.

5. The toner according to claim 2, wherein R¹ to R³ each independently represent an alkoxy group or a hydroxy group.

6. The toner according to claim 1, wherein the content of the ester bond in the resin A is at least 15.0 mass %.

7. The toner according to claim 1, wherein the silicon atom content in the resin A is from 0.02 mass % to 10.00 mass %.

8. The toner according to claim 1, wherein the resin A contains a polyester segment.

9. The toner according to claim 1, wherein the resin A contains as a constituent component a monomer unit derived from an aromatic ring-bearing compound.

10. The toner according to claim 1, wherein the resin A contains as a constituent component a monomer unit derived from an at least trihydric polyhydric alcohol or an at least tribasic polyvalent carboxylic acid.

11. The toner according to claim 1, wherein the weight-average molecular weight of the resin A is from 3000 to 100000.
